(19) United States
(12) Patent Application Publication
(10) Pub. No.: US 2014/0274682 A1
(43) Pub. Date: Sep. 18, 2014

(54) COMPOSITIONS AND METHODS FOR REDUCING DUST AND REPELLING, CONTROLLING, OR DIRECTING AN INSECT

(71) Applicant: Bayer CropScience LP, Research Triangle Park, NC (US)

(72) Inventors: Tai-Teh WU, Chapel Hill, NC (US); Dick ROGERS, Chapel Hill, NC (US); Jian ZHANG, Durham, NC (US); Robert CROFT, Durham, NC (US); Chi Yu Roy CHEN, Raleigh, NC (US); Ronald REICHERT, Cary, NC (US); William G. HAIRSTON, Wake Forest, NC (US)

(73) Assignee: Bayer CropScience LP, Research Triangle Park, NC (US)

(21) Appl. No.: 14/197,805

(22) Filed: Mar. 5, 2014

Related U.S. Application Data
(60) Provisional application No. 61/791,958, filed on Mar. 15, 2013.

(51) Int. Cl. A01N 25/10; A01C 1/06; A01N 31/04; A01N 51/00; A01N 35/02; A01N 31/16

(52) U.S. Cl. CPC A01N 25/10; A01N 35/02; A01N 31/16; A01N 31/04; A01N 51/00; A01C 1/06
USPC 504/100; 514/675; 514/720; 514/729; 514/365; 514/692; 424/725; 424/770; 424/745

(57) ABSTRACT

Methods for reducing dust emission by coating a seed with a lubricant composition are described herein. The disclosure also provides for a method of reducing insect exposure to vacuum planter dust released during seed planting by applying a lubricant composition to a seed. Methods for increasing seed lubricity by coating a seed with a lubricant composition are also described. Compositions and seeds useful in these methods are also described.

### CROSS REFERENCE TO RELATED APPLICATION

This application claims the benefit of U.S. Provisional Application Ser. No. 61/791,958, filed Mar. 15, 2013, the content of which is herein incorporated by reference in its entirety.

### FIELD

Methods for reducing dust by treating or coating a seed with a lubricant composition are described. The disclosure also provides for methods of reducing dust while selectively repelling, controlling, or directing an insect of interest. Methods for increasing seed lubricity by coating a seed with a lubricant composition are also described. Compounds, compositions, and methods for coating a structure with a selective insect repelling, controlling, and/or directing compound or composition described herein are also provided. Compositions and seeds useful in these methods are also described.

### BACKGROUND

It is believed that vacuum planters release a certain amount of dust during the planting of seeds. It is also believed that the amount of seed dust released during seed planting depends on a variety of factors, such as the technique or mechanism employed during the seed planting stage. Other factors contributing to seed dust associated with planting include the type of seed coating used during planting. It is believed that while traditional planter lubricants, such as talc and graphite, provide lubrication to help seed flow through the planter mechanism, such traditional planter lubricants may not possess a high enough level of lubricity to prevent some level of seed attrition that may result in the loss of small amounts of insecticide from the seed surface. As such, there is a need to find an alternative to traditional planter lubricants that are capable of limiting insecticidal dust emissions during seed planting, such as a novel compound or composition capable of both reducing seed dust and selectively repelling, controlling, or directing insects. To this end, the disclosed compositions and methods have the ability to both reduce and control seed dust in a manner that was not previously recognized as well as selectively repel, control, or direct an insect of interest.

### SUMMARY

In an aspect, the disclosure provides for a dust reducing composition including:
(a) one or more lubricant compositions described herein; and
(b) one or more insect repelling, controlling, and/or directing compounds or compositions described herein.

In an aspect, the disclosure provides for a method of reducing dust by applying a lubricant composition to a seed. In another aspect, the disclosure provides for a method of reducing dust emission and repelling, controlling, or directing an insect by treating a seed with:
(a) one or more lubricant compositions described herein; and
(b) one or more insect repelling, controlling, and/or directing compounds or compositions described herein.

In another aspect, the disclosure provides for a seed including

(a) one or more insecticidal, pesticidal, fungicidal, or herbicidal active agents; and

(b) one or more organic lubricant compositions described herein; and

(c) one or more insect repelling, controlling, and/or directing compounds or compositions described herein.

In another aspect, the disclosure provides for a seed coating including

(a) one or more insecticidal, pesticidal, fungicidal, or herbicidal treating agent seed coating described herein; and

(b) one or more organic lubricant compositions described herein; and

(c) one or more insect repelling, controlling, and/or directing compounds or compositions described herein.

In another aspect, the disclosure provides for a composition including

(a) talc, graphite, or combinations thereof; and

(b) one or more insect repelling, controlling, and/or directing compounds or compositions described herein.

In yet another aspect, the disclosure provides for an article or structure comprising, consisting of, or consisting essentially of one or more insect repelling, controlling, and/or directing compounds or compositions described herein.

In an aspect, the lubricant is an organic lubricant. In another aspect, the organic lubricant described herein is a wax. In an aspect, the wax is a dust reducing compound or composition selected from the group consisting of polyethylene wax, carnuba wax, paraffin wax, polypropylene wax, oxidized polyethylene wax, montan wax, microcrystalline wax, Fischer-Tropsch wax, amide wax, ethylene-acrylic-acid wax, polyolefin wax, ethylene bis stearamide wax, bees wax, lanolin wax, and vegetable wax. In yet another aspect, the wax is a polyethylene wax, oxidized polyethylene wax, or powdered oxidized polyethylene wax.

In another aspect, the dust reducing lubricant is applied to a seed in an amount that is sufficient to reduce or mitigate dust. In another aspect, the dust reducing lubricant is applied to a seed at about 1.0-3.0 oz/cwt or about 0.5-4.0 oz/cwt. lubricant

In an aspect, the insect repelling, controlling, or directing compound is selected from one or more compounds of Formula I-IX.

In another aspect, the repelling or directing compound described herein includes at least one C₆-C₁₅ ketone or C₇-C₁₂ ketone compound.

In another aspect, the C₆-C₁₅ ketone is selected from the group consisting of 3-heptanone, 4-heptanone, cycloheptanone, 2-octanone, 3-octanone, cyclooctanone, 2-nonanone, cyclononanone, 2-decanone, 3-decanone, 4-decanone, 5-decanone, 2-undecanone, 2-dodecanone, 2-trideconone, 2-tetradecanone, 2-pentadecanone, 2-hexadecanone, 2-heptadecanone, cyclodeconone, and sulfur analogs of 2-decanone.

In yet another aspect, the composition further includes an agent selected from the group consisting of one or more of camphor, camphor oil, camphor powder, tea tree oil, essential oils of tea tree, pine oil, rosemary powder, and rosemary oil which also operate to provide directing, controlling or repelling in an additive and/or synergistic manner in combination with the repellent compounds of the Formula I-IX of the present invention.

### BRIEF DESCRIPTION OF THE FIGURES

FIG. 1 sets forth the total grams of dust per 100,000 kernels and grams of clothianidin in total dust per 100,000 kernels for seeds treated with a Poncho/VOTiVO and talc treatment as compared to a treatment of Poncho/VOTiVO and polyethylene wax used as a lubricant at 0.56 oz/cwt seed, 0.75 oz/cwt seed, 1.5 oz/cwt seed, and 3 oz/cwt seed as measured by a John Deere Vacuum Meter.

FIG. 2 sets forth corn dust levels for seeds treated with a Poncho/VOTiVO and talc treatment as compared to a treatment of Poncho/VOTiVO and oxidized polyethylene wax used as a lubricant at 0.56 oz/cwt seed, 0.75 oz/cwt seed, 1.5 oz/cwt seed, and 3 oz/cwt seed as measured by a John Deere Vacuum Meter.

FIG. 3 sets forth the total grams of dust per 100,000 kernels and grams of clothianidin in total dust per 100,000 kernels for seeds treated with a Poncho 1250+VOTiVO and talc treatment as compared to a treatment of Poncho 1250+VOTiVO and oxidized polyethylene wax used as a lubricant at 0.56 oz/cwt seed, 0.75 oz/cwt seed, 1.5 oz/cwt seed, and 3 oz/cwt seed as measured by a John Deere Vacuum Meter.

FIG. 4 sets forth measures corn dust levels for seeds treated with a Poncho 1250+VOTiVO and talc treatment as compared to a treatment of Poncho 1250+VOTiVO and polyethylene wax used as a lubricant at 0.56 oz/cwt seed, 0.75 oz/cwt seed, 1.5 oz/cwt seed, and 3 oz/cwt seed as measured by a John Deere Vacuum Meter.

FIG. 5 sets forth the total grams of dust per 100,000 kernels and grams of clothianidin in total dust per 100,000 kernels for seeds treated with a Poncho/VOTiVO and graphite treatment as compared to a treatment of Poncho/VOTiVO and an oxidized polyethylene wax used as a lubricant at 0.56 oz/cwt seed, 0.75 oz/cwt seed, 1.5 oz/cwt seed, and 3 oz/cwt seed as measured by a Case IH Vacuum Meter.

FIG. 6 sets forth measures corn dust levels for seeds treated with a Poncho/VOTiVO and graphite treatment as compared to a treatment of Poncho/VOTiVO and polyethylene wax used as a lubricant at 0.56 oz/cwt seed, 0.75 oz/cwt seed, 1.5 oz/cwt seed, and 3 oz/cwt seed as measured by a Case IH Vacuum Meter.

FIG. 7 sets forth the total grams of dust per 100,000 kernels and grams of clothianidin in total dust per 100,000 kernels for seeds treated with a Poncho 1250+VOTiVO and graphite treatment as compared to a treatment of Poncho 1250+VOTiVO and an oxidized polyethylene wax used as a lubricant at 0.56 oz/cwt seed, 0.75 oz/cwt seed, 1.5 oz/cwt seed, and 3 oz/cwt seed as measured by a Case IH Vacuum Meter.

FIG. 8 sets forth measures corn dust levels for seeds treated with a Poncho 1250+VOTiVO and talc treatment as compared to a treatment of Poncho 1250+VOTiVO and an oxidized polyethylene wax used as a lubricant at 0.56 oz/cwt seed, 0.75 oz/cwt seed, 1.5 oz/cwt seed, and 3 oz/cwt seed as measured by a Case IH Vacuum Meter.

FIG. 9 sets forth the feeding station arrangement for the honeybee repulsion experiment of Example 5. Panel (A) sets forth the bee cage positions on the left portion of panel (A) with the randomized feeding station positions on the right portion of panel (A). Panel (B) sets forth an alignment of the randomized feeding station positions with a distance of two meters between feeding stations.

FIG. 10 sets forth a honeybee feeding station with a solution of 2-decanone with a 50% sucrose solution after 8 hours.

FIG. 11 sets forth a honeybee feeding station with a 50% sucrose solution after 8 hours.

FIG. 12 sets forth a side by side comparison of the repulsion characteristics of (A) 2-decanone (left panel) with a 50% sucrose solution as compared to (B) a 50% sucrose control (right panel) on honeybees after a 8 hour period of time.

FIG. 13 sets forth the number of honeybees visiting feeding stations for T1 (control—50% sucrose), T2 (control—50% sucrose), T3 (control—50% sucrose), T4 (Camphor oil), T5 (Ajowan oil), T6 (Camphor powder), T7 (Rosemary oil), and T8 (2-Decanone) over a varied period of time. 50% sucrose was included with T4 (Camphor oil), T5 (Ajowan oil), T6 (Camphor powder), T7 (Rosemary oil), and T8 (2-Decanone).

FIG. 14 sets forth the mean number of honeybees visiting feeding station over a period of four hours for T1 (control—50% sucrose), T2 (control—50% sucrose), T3 (control—50% sucrose), T4 (Camphor oil), T5 (Ajowan oil), T6 (Camphor powder), T7 (Rosemary oil), and T8 (2-Decanone). 50% sucrose was included with T4 (Camphor oil), T5 (Ajowan oil), T6 (Camphor powder), T7 (Rosemary oil), and T8 (2-Decanone).

### DETAILED DESCRIPTION

### Insect Repelling, Controlling, or Directing Compound

The disclosure provides for an insect repelling, controlling, and/or directing compound or composition. In another aspect, a repelling, controlling, and/or directing compound or composition described herein repels all, a broad range, or a subset of insects. In another aspect, a repelling, controlling, and/or directing compound or composition described herein repels some but not all insects.

In an aspect, an insect repelling, controlling, or directing compound or composition described herein can control or alter the behavior of an insect, for example a pollinating insect, such as a bee. In another aspect, the disclosure provides for a repelling, controlling, or directing compound or composition of Formula I:

[chemical structure]

In an aspect, R₁ and R₂ are independently selected from an alkyl, aryl, phenyl, substituted phenyl, fused phenyl, heterocyclic ring, aryl alkyl, vinyl, acetyl, vinyl alky, propargyl, and ally group.

In another aspect, R₁ and R₂ are independently selected from methyl, ethyl, propyl, isopropyl, cyclopropyl, butyl, iso-butyl, tert-butyl, pentyl, hexyl, heptyl, octyl, nonyl, decyl, undecyl and substituted or non-substituted C₂-C₁₄-alkyl, substituted or non-substituted C₂-C₁₄ alkenyl, a substituted or non-substituted C₂-C₁₄-alkynyl.

In a further aspect, R₁ is H and R₂ is an alkyl or aryl or R₁ is alkyl or aryl and R₂ is H.

In another aspect, an alkyl group is a straight chain, branched, cyclic, cyclic alkyl optionally substituted with halogen, such as F, Cl, Br, I, oxygen, hydroxyl, alkoxy, cyano, aryloxy, C═C, C≡C; nitrogen, NH2, alkyl amino, dialkyl amine trialkylamino; SH, alkylthio and oxidation states, arylthio and oxidation states; amido, monoalkylamino, dialkylamino, and ureido.

In yet another aspect, R₁ and R₂ can form a ring, such as a cycloalkyl ring, for example, a cyclehexyl, cycloheptyl, cyclopentyl, cyclopropyl, cyclobutyl, cyclooctyl, fused alkyl ring, such as camphor. In another aspect, the R₁ and R₂ ring is a phenyl ring optionally substituted with one or more of halogen, OH, alkoxy, cyano, amino alkylamino, dialkylamino, SH, alkylthio and oxidation states, pheoxy, formyl, alkylcarbonyl, alkoxycarbonyl, haloalkyl, haloalkoxy, polyhaloalkyl, polyhaloalkoxy, perhaloalkyl, perhaloalkoxy, amido, alkylamino, amino, dialkylamino, hydroxycarbonyl, alkyl carbonyl, aryl carbonyl, and alkoxycarbonyl groups.

In another aspect, R₁ and R₂ are linked together to form a substituted or unsubstituted (CH₂)₃, (CH₂)₄, (CH₂)₅, (CH₂)₆, (CH₂)₇, (CH₂)₈, (CH₂)₉, (CH₂)₁₀, (CH₂)₁₁, (CH₂)₁₂, and a (CH₂)₁₃ ring structure.

In yet another aspect R₁ methyl or ethyl and R₂ is selected from the group consisting of methyl, ethyl, propyl, isopropyl, cyclopropyl, butyl, iso-butyl, tert-butyl, pentyl, hexyl, heptyl, octyl, nonyl, decyl, undecyl and substituted or non substituted C₂-C₁₄-alkyl, substituted or non substituted C₂-C₁₄ alkenyl, a substituted or non substituted C₂-C₁₄-alkynyl.

In an aspect, the repelling, controlling, or directing compound is represented by Formula II, where R₁ and R₂ are defined above:

[chemical structure]

In an aspect, the repelling, controlling, or directing compound is represented by Formula III, where R₁ and R₂ are defined above:

[chemical structure]

In an aspect, the repelling, controlling, or directing compound is represented by Formula IV, where R₁ and R₂ are defined above:

[chemical structure]

In an aspect, the repelling, controlling, or directing compound is represented by Formula V, where R₁ and R₂ are defined above:

[chemical structure]

In an aspect, the repelling, controlling, or directing compound is represented by Formula VI, where R₁ and R₂ are defined above:

[chemical structure]

In an aspect, the repelling, controlling, or directing compound is represented by Formula VII, where R₁ and R₂ are defined above:

[chemical structure]

In an aspect, the repelling, controlling, or directing compound is represented by Formula VIII, where R₁ and R₂ are defined above and wherein R₃ and R₄ are individually selected from H, alkyl, methyl, ethyl, propyl, or butyl. In another aspect R₃ and R₄ can be any of the above referenced alkyl groups.

[chemical structure]

In an aspect, the repelling, controlling, or directing compound is represented by Formula IX, where R₁ and R₂ are defined above:

[chemical structure]

In another aspect, the disclosure provides for optically active and/or geometric isomers and/or salts thereof of compounds of Formula I-IX. In yet another aspect, the disclosure provides for metabolites, analogues, homologues, isomers, diastereomers, conjugate isomers, tautomers, and salts thereof of compounds of Formula I-IX. In another aspect, the methodology described herein can be practiced with one or more compounds represented by Formula I-IX.

In an aspect, the insect repelling, controlling, or directing compound or composition is selected from the group consisting of a ketone, such as a C₅-C₇ ketone, C₆-C₉ ketone, C₇-C₁₀ ketone, a C₈-C₁₂ ketone, C₁₀-C₁₂ ketone, a C₇-C₁₅ ketone, or a methyl ketone. In another aspect, the insect repelling, controlling, or directing compound is selected from one or more of 2-pentanone, cyclopentanone, 2-pentanimine, 2-hexanone, 3-hexanone, cyclohexanone, 2-methylcyclohexanone, 3-methylcyclohexanone, 4-methylcyclohexanone, 2-heptanone, 3-heptanone, 4-heptanone, heptyl, 1-acetyl, cycloheptanone, 2-octanone, 3-octanone, cyclooctanone, 2-nonanone, cyclononanone, 2-decanone (methyl-n-octyl ketone), 2-undecanone (methyl-n-nonylketone), 2-dodecanone, 1,3-dioxolane, 2-methyl-2-octyl, 2-trideconone, 2-tetradecanone, 2-pentadecanone, 2-hexadecanone, 2-heptadecanone, 2-nonanethione, cyclodeconone, decane, 2,2-dimethoxy, sulfur analog of 2-decanone, 2-decanimine, (+)-2-decanol, 2-decanol, 2,9-decanedione, 2,11-dodecanedione, 2,5-dodecanedione, 2,2-decanediol, 1-undecen-2-ol, 3-decanone, 4-decanone, 5-decanone, 9-methyl, decanal, ethanone, 1-[3-methyl-4-(trifluoromethyl)phenyl], ethanone, 2,2,2-trifluoro-1-phenyl, 5,9-undecadien-2-one, 6,10-dimethyl-, (5E)-, 2-pentadecanone, 4-methylcyclohexanone, p-methylacetophenone, propionphenone, 2-Hydroxyacetophenone, 2,9-decanedione, 2,11-dodecanedione, 2,5-dodecanedione, and 2-hydroxy acetophenone.

In an aspect, the insect repelling, controlling, or directing compound or composition is selected from the group consisting of a compound from 3-heptanone, 4-heptanone, cycloheptanone, 2-octanone, 3-octanone, cyclooctanone, 2-nonanone, cyclononanone, 2-decanone, 3-decanone, 4-decanone, 5-decanone, 2-undecanone, 2-dodecanone, 2-trideconone, 2-tetradecanone, 2-pentadecanone, 2-hexadecanone, 2-heptadecanone, cyclodeconone, and sulfur analogs of 2-decanone.

In another aspect, a repelling, controlling, or directing compound or composition is selected from the group consisting of Table 1:

TABLE 1

| | |
|---|---|
| [chemical structure] | Compound 1 |
| [chemical structure] | Compound 2 |
| [chemical structure] | Compound 3 |
| [chemical structure] | Compound 4 |
| [chemical structure] | Compound 5 |
| [chemical structure] | Compound 6 |
| [chemical structure] | Compound 7 |
| [chemical structure] | Compound 8 |
| [chemical structure] | Compound 9 |
| [chemical structure] | Compound 10 |
| [chemical structure] | Compound 11 |
| [chemical structure] | Compound 12 |
| [chemical structure] | Compound 13 |
| [chemical structure] | Compound 14 |
| [chemical structure] | Compound 15 |
| [chemical structure] | Compound 16 |
| [chemical structure] | Compound 17 |
| [chemical structure] | Compound 18 |
| [chemical structure] | Compound 19 |
| [chemical structure] | Compound 20 |
| [chemical structure] | Compound 21 |
| [chemical structure] | Compound 22 |
| [chemical structure] | Compound 23 |
| [chemical structure] | Compound 24 |
| [chemical structure] | Compound 25 |
| [chemical structure] | Compound 26 |
| [chemical structure] | Compound 27 |
| [chemical structure] | Compound 28 |
| [chemical structure] | Compound 29 |
| [chemical structure] | Compound 30 |
| [chemical structure] | Compound 31 |
| [chemical structure] | Compound 32 |
| [chemical structure] | Compound 33 |

[chemical structure]

In an aspect, methyl ketones of C₅-C₇ have a lower repellent activity than those with C₈-C₁₂. In an aspect, by “lower” it is meant that the methyl ketones of C₅-C₇ repel, control, or direct a lower percentage of insects of interest relative to C₈-C₁₂ ketones. In another aspect, by “lower” it is meant that the methyl ketones of C₅-C₇ repel, control, or direct an insect for a shorter period of time, less insects of interest, or combinations of interest relative to C₈-C₁₂ ketones. In another aspect, the volatility of methyl ketones of C₅-C₇ is higher than that of methyl ketones of C₈-C₁₂.

In another aspect, methyl ketones of C₅-C₇ have a lower repellent activity than those with C₈-C₁₅. In another aspect, the volatility of methyl ketones of C₅-C₇ is higher than that of methyl ketones of C₈-C₁₅.

In yet another aspect, the disclosure provides for one or more of an insect repelling, controlling, or directing compound or composition selected from the group consisting of pine oil, tea tree oil, essential oil of tea tree, densifolia leaf essential oil, essential oil of ocimum santum, systox, phenol, alkaloids, carum copticum oil, propionic anhydride, butyric anhydride, methyl salicylate, 6-hexatriacontene, stenpcereol, 27,28,29-trisnor-13-15-17-meratriene, samaderine E, phenylacetaldehyde, benzaldehyde, Swertia densifolia leaf essential oil, linalool, ambrette seed oil, cascarilla bark oil, leaf oil, cascarilla bark oil, rue oil, rue flower oil, terpineol, stearic acid, hydroquinone and octadecanal, methyl anthranilate, methyl anthranilate, creosote, acetic acid and propionic acid, N,N-diethyltoluamide, dimethyl phthalate, and isopropyl cinnamate. The disclosure also provides for one or more of an insect repelling, controlling, or directing compound or compound combinations selected from the group consisting of citronella (for example, Cymbopogon spp, Cymbopogon nardus, Cymbopogon winterianus and Cymbopogon citratus), eucalyptus (Eucalyptus spp.), lemon eucalyptus (Corymbia citriodora), cinnamon (Cinnamomum verum), castor (Ricinus communis), rosemary (Rosmarinus officinalis), cedar (Cedrus spp.), peppermint (Mentha piperita), clove (Syzygium aromaticum), geranium (Pelargonium graveolens), verbena (Verbena spp., Verbena officinalis), pennyroyal (Mentha pulegium), lavender (Lavandula spp.), pine (Pinus spp.), cajeput (Melaleuca spp.; Melaleuca leucadendra), basil (Ocimum basilicum), thyme (Thymus vulgaris), pandan (Pandanus amaryllifolius), allspice (Pimenta dioica), soybean (Glycine max), garlic (Allium sativum), DEET, Picaridin, p-Mentane-3,8-diol, Permethrin, Allethrin, Metofluthrin, Geraniol, Eugenol, Cinnamaldehyde, Alkaloids, p-cymene, linalool, α-pinene, β-pinene, sabinene, myrcene, α-phellandrene, α-terpinene, α-terpineol (a component of tea tree oil and pine oil), α-ter, limonene, 1,8-cineole, y-terpinene, terpinolene, terpinen-4-ol and α-terpineol, copticum, and Ptychotis oil.

In an aspect, the compounds and compositions described herein exhibit a synergistic influence when combined. In another aspect, compounds of Formula I-IX exhibit a synergistic influence when combined. In another aspect, compounds I-32 in Table 1 exhibit a synergistic influence when combined. In yet another aspect, these compounds produce an additive effect.

In an aspect, the insect repelling, controlling, or directing compound or compositions comprises, consists of, or consists essentially of any of the repelling, controlling, or directing compound or compositions described herein.

In another aspect, the disclosure provides for a composition comprising, consisting essentially of, or consisting of 2-decanone and rosemary oil. In another aspect, the disclosure provides for a composition comprising, consisting essentially of, or consisting of 2-decanone and camphor. In yet another aspect, the disclosure provides for a composition comprising, consisting essentially of, or consisting of 2-decanone, rosemary oil, and camphor. In an aspect, these compounds produce a synergistically effect. In yet another aspect, these compounds produce an additive effect.

In another aspect, the insect repelling, controlling, or directing compound or composition described herein works by influencing or altering the senses of an insect. In another aspect, the compound or composition alters the olfactory senses, taste, sight, tactile (e.g. burning or itch) or other physical characteristics of an insect, or in another aspect of the invention, the repelling, controlling or directing compound of the present invention can be combined with one or more compounds that act on one or more senses in a synergistic or additive manner, to affect and thereby control, direct or repel the insect across more than one sense.

In another aspect, the insect repelling, controlling, or directing compound, compound combination, or composition does not include heptanone, 2-heptanone, compounds that mimic the activity of 2-heptonone, 2-undecanone, 2-dodecanone, 2-trideconone, N,N-diethyl-m-toluamide (“DEET), benzaldehyde, phenol, or any combination thereof.

In an aspect, the insect repelling, controlling, or directing composition includes 2-decanone and not 2-heptanone. In an aspect, the composition includes 2-decanone and not 2-undecanone. In another aspect, the composition includes 2-decanone and not 2-dodecanone. In yet another aspect, the composition includes 2-decanone and not 2-trideconone. Yet in another aspect, the composition includes 2-decanone and not 2-heptanone, 2-undecanone, 2-dodecanone, or 2-trideconone.

In an aspect, the composition does not contain a neem plant, neem part thereof, neem oil, or neem extract.

### Methods of Repelling, Controlling, or Directing Insects and Reducing Seed Dust

The disclosure provides for compounds, compositions, and methods of reducing dust. In an aspect, any of the below dust reducing compounds and compositions described herein are used in combination with at least one insect repelling, controlling, or directing compound or composition described herein.

The disclosure provides for a method of reducing dust emission, pesticidal dust, insecticidal dust, herbicidal and/or fungicidal dust. In another aspect, the disclosure provides for a method of reducing dust emission, pesticidal dust, insecticidal dust, herbicidal and/or fungicidal dust by coating a seed with a composition described herein, for example a lubricant composition.

In another aspect, one or more repelling, controlling, or directing compounds or compositions described herein can be used in together with compounds, compositions, or methods for reducing seed dust as described herein.

In yet another aspect, the disclosure provides for a method of reducing dust emission, pesticidal dust, insecticidal dust, or fungicidal dust by:
(1) applying a treating agent to a seed; and
(2) applying a lubricant composition to the treated seed such that the lubricant composition reduces dust emission, pesticidal dust, insecticidal dust, herbicidal and/or fungicidal dust.

In an aspect, the disclosure provides for a method of repelling, controlling, or directing an insect by applying (1) a repelling, controlling, or directing compound or composition herein to seed in combination with a (2) dust reducing composition described herein. In another aspect, a compound or composition described herein is applied to wet seed. The disclosure also provides for a method of increasing seed lubricity by coating a seed with a dust reducing composition in conjunction with a compound or composition described herein.

In an aspect, a repelling, controlling, or directing compound or composition described herein is applied to a seed before, after, or during planting of the seed. In another aspect, a repelling, controlling, or directing compound or composition described herein is applied in a hopper with a seed prior to or during planting.

In an aspect, the disclosure provides for a method of coating a seed with a treating agent and a lubricant composition described herein, for example a wax composition, wherein the coated seed emits a reduced amount of dust, pesticidal dust, insecticidal dust, or dust. In an aspect, one or more repelling, controlling, or directing compounds is incorporated into the dust in an amount sufficient to selectively repel, control, or direct an insect of interest, for example a bee.

The disclosure also provides for a method of reducing vacuum planter dust released during planting. In an aspect, the disclosure provides for a method of reducing insect exposure to vacuum planter dust released during planting. In another aspect, the vacuum planter dust is an insecticidal, pesticidal, or fungicidal dust.

In an aspect, the disclosure provides for a method of improving seed flow by applying or treating seed with a composition described herein. In another aspect, a composition described herein is applied to wet seed. The disclosure also provides for a method of increasing seed lubricity by coating a seed with a composition described herein. In an aspect, the disclosure provides for a method of lowering lubricity at lower use rates than those afforded by the coating of a seed with talc or graphite. The disclosure also provides for a method increasing the level of lubricity in an amount that is sufficient to reduce seed attrition that may result in the loss of small amounts of insecticide from the seed surface.

The disclosure also provides for a method of adding a treating agent, a wax, and/or at least one repelling, controlling, or directing compound or composition described herein to a seed.

In an aspect, a lubricant compound or composition and one or more repelling, controlling, or directing compounds or compositions are added to a pre-treated seed prior, at the same time, or after the pre-treated seed is placed in soil. In an aspect, the seed is pre-treated with an insecticidal, pesticidal, or fungicidal compound or composition described herein.

In another aspect, a lubricant compound or composition, one or more repelling, controlling, or directing compounds or compositions, and/or an insecticidal, pesticidal, or fungicidal compound or composition described herein are added to a seed prior, at the same time, or after the seed is placed in soil. In an aspect, the seed is untreated or pre-treated. In an aspect, the seed is treated with one or more application steps and in an amount that is sufficient to reduce dust and repel an insect of interest from a seed.

In another aspect, a wax composition, insect repelling, controlling, or directing compound or composition, or combinations thereof are added to a pre-treated seed prior to the pre-treated seed being placed in soil. In another aspect, a seed is pre-treated by both a treating agent and a wax composition described herein prior to planting. In yet another aspect, a composition described herein can be applied to seed in a planter or hopper either manually or with a mechanized system, such as a mechanized metering system. In an aspect, the powder form of a wax is added to seed in a planter.

In an aspect, a treating agent, wax, and/or repelling, controlling, and/or directing compound or composition are added to a seed prior to placing the seed into a bag or container. In another aspect, the components are added to a seed prior or after the bag and/or container of seed has been shipped to a planting site. In another aspect, after the seed arrives at the planting site, a lubricant composition and/or repelling, controlling, and/or directing compound or composition described herein is added to the seed. In yet another aspect, a lubricant composition and/or repelling, controlling, and/or directing compound or composition described herein is added to pre-treated seed (seed previously treated with a treating agent) in a planter mechanism or hopper of the planting mechanism. In another aspect, a treating agent, a lubricant, and/or a repelling, controlling, and/or directing compound are added to a seed prior to the seed being loaded on a planter or hopper for planting. In yet another aspect, a treating agent, a first lubricant, and or a first repelling, controlling, and/or directing compound or composition are added to seed prior to the seed being loaded on a planter or hopper for planting and a second lubricant composition and/or a second repelling, controlling, and/or directing compound or composition are added to seed in the planter or hopper.

In an aspect, the dust, insecticidal dust, herbicidal dust, pesticidal dust, or fungicidal dust emission is reduced relative to traditional lubricants, such as talc or graphite. In yet another aspect, a lubricant composition described herein, for example a wax composition, reduces the dust, insecticidal dust, herbicidal dust, pesticidal dust, or fungicidal dust emission from the planter mechanism, such as an air or vacuum planter. In an aspect, the planter mechanism is a John Deere, Case IH, Kinze, AGCO White, Great Plains, or Precision Planting vacuum planter.

The disclosure also provides for a method of reducing active agent dust, pesticide, herbicidal, fungicide, or insecticide by applying a composition described herein to a seed.

In an aspect, a composition capable of being used with the methods described herein comprises, consists essentially of, or consists of a lubricant composition. In another aspect, a composition capable of being used with the methods described herein comprises, consists essentially of, or consists of a wax, polyethylene wax, powdered polyethylene wax, or Michem®Wax 437 (Michelman).

In an aspect, a composition described herein can include one or more lubricant compositions. In another aspect, a lubricant composition is an organic lubricants. In another aspect, the lubricant composition is a wax, for example, polyethylene, powdered polyethylene, carnuba, paraffin, polypropylene, an oxidized polyethylene wax, montan waxes, microcrystalline waxes, Fischer-Tropsch waxes, amide waxes, Ethylene-Acrylic-Acid (EAA) waxes, polyolefin waxes, Ethylene bis stearamide (EBS) waxes, animal waxes (bees wax & lanolin), vegetable waxes (carnauba & candelilla), or slac and scale waxes. In another aspect, a lubricant composition is Teflon (polytetrafluoroethylene).

In an aspect, a composition capable of being used with the methods described herein comprises, consists essentially of, or consists of a treatment agent and a lubricant composition, for example, a wax. In another aspect, a composition capable of being used with the methods described herein comprises, consists essentially of, or consists of a treatment agent together with a polyethylene wax or powdered polyethylene wax. In an aspect, the wax is used as a planter lubricant.

In an aspect, a repelling, controlling, or directing compound or composition described herein and/or dust reducing lubricant or wax composition described herein can be used in conjunction with an insecticidal, herbicidal and/or fungicidal active agent. In an aspect, the disclosure provides for a composition further including one or more of the following:

(a) acetylcholine esterase inhibitor, for example, carbamate and organophosphates;

(b) a GABA-gated chloride channel antagonist, for example, cyclodiene organochlorine, phenylpyrazole (Fiproles), ethiprole, and fipronil;

(c) sodium channel modulator, for example, methoxychlor and pyrethroids;

(d) nicotinic acetylcholine receptor agonists/antagonists, for example, neonicotinoid, nicotine, nensultap, cartap hydrochloride, and nereistoxin analogues;

(e) nicotinic acetylcholine receptor agonists (allosteric), for example, a spinosyns or spinosad; and

(f) chloride channel activators, for example, avermectin, abamectin, emamectin bezoate, milbemycins, and milbemectin.

In another aspect, a repelling, controlling, or directing compound or composition described herein and/or dust reducing lubricant or wax composition described herein can be used in conjunction with one or more active agents selected from the group consisting of acetamiprid, clothianidin, dinotefuran, imidacloprid, nitenpyram, thiacloprid, thiamethoxam, ethiprole, fipronil, imidacloprid, spiromesifen, beta-cyfluthrin, spirodiclofen, flubendiamide, thiodicarb, spirotetramat, Poncho, Gaucho, Votivo, Votivo with an additional insecticide, Nipsit INSIDE® (Valent), Platinum® (Syngenta), Admire® Pro (Bayer CropScience), Cruiser (Syngenta), Gaucho (Bayer CropScience), Leverage® (Bayer CropScience), Actara (Syngenta), Venom (Valent), Provado® (Bayer CropScience), Movento® (Bayer CropScience), Larvin® (Bayer CropScience), Belt® (Bayer CropScience), Sepresto® (Bayer CropScience), Leverage 360® (Bayer CropScience), Envidor® (Bayer CropScience), Baythroid® XL (Bayer CropScience), Oberon® (Bayer CropScience), Calypso (Bayer CropScience), Alias (Mana), Pasada (Mana), Couraze (Cheminova), Assail® (DuPont), Poncho®/VOTiVO™ (Bayer CropScience), Poncho® 1250+VOTiVO™ (Pioneer), Poncho® Beta (Bayer CropScience), Poncho® 600 (Bayer CropScience), Gaucho® 600 (Bayer CropScience), Gaucho®-XT (Bayer CropScience), Aeris® (Bayer CropScience), Prosper® FX (Bayer CropScience), Prosper® Evergol (Bayer CropScience), and/or Requiem® (Agroquest).

In an aspect, a composition described herein includes a mixture or combination of lubricant composition and treatment agent described herein.

In another aspect, a composition or method described herein does not include an inorganic lubricant composition. Inorganic compounds, for example talc and graphite, encompass compounds such as carbides, carbonates, simple oxides of carbon, cyanides, and allotropes of carbon.

In an aspect, a composition or method described herein does not include talc. In another aspect, a composition or method described herein does not include graphite or graphite blends. In yet another aspect, a composition or method described herein does not include blends of graphite and/or talc. In another aspect, a composition or method described herein contains trace amount of talc or graphite. In another aspect, a composition or method described herein contains less than about 5%, less than about 10%, less than about 20%, less than about 20%, less than about 30%, less than about 40%, or less than about 50% by weight of talc, graphite, or a combination of talc or graphite.

In yet another aspect, a composition described herein may be blended with inert materials to improve handling or packaging, for example, silica, starches (natural and derived), clays, and other minerals.

In an aspect, a composition described herein is applied as a powder to a seed at the same time or before the planter fills the planter hopper with seed. In another aspect, a composition described herein is applied as a dry powder to a seed as a farmer fills the planter hopper with seed.

In an aspect, a composition described herein, such as a wax, is capable of providing lubricity at a lower use rate as compared to conventional lubricants, such as talc or graphite. In another aspect, a wax described herein provides for improved seed to seed and seed to planter mechanism slip and reduces insecticide loss from seed due to attrition as it passes through the vacuum planter mechanisms.

In another aspect, a lubricant composition described herein provides an increased level of lubricity to reduce seed to seed and seed to planter mechanism attrition as compared to traditional lubricant compositions, such as talc or graphite. In an aspect, a lubricant composition described herein is also effective at lower application rates than talc or graphite.

In an aspect, the methods and compositions described herein reduce dust, insecticidal dust emissions, pesticidal dust emissions, herbicidal dust emissions, or fungicidal dust emissions by about 5% to about 20%, about 20% to about 60%, about 40% to about 70%, about 50% to about 90%, about 60% to about 80%, about 65% to about 95%, about 80% to about 95%, or about 5%, about 15%, about 25%, about 40%, about 50%, about 60%, about 70%, about 80%, about 90%, or about 95%, or about 5% or more, about 15% or more, about 25% or more, about 40% or more, about 50% or more, about 60% or more, about 70% or more, about 80% or more, about 90% or more, or about 95% or more. In yet another aspect, the dust emissions, insecticidal dust emissions, pesticidal dust emissions, or fungicidal dust emissions is reduced relative to traditional lubricants, such as talc or graphite.

In an aspect, a composition described herein is applied to a seed at a rate of about 0.1-5.0 oz/cwt (ounces/hundredweight), about 0.5-4.0 oz/cwt, about 1.0-3.5 oz/cwt, about 1.5-3.0 oz/cwt, about 2.0-3.0 oz/cwt, about 2.0-2.5 oz/cwt, or about 0.2 oz/cwt, about 0.5 oz/cwt, about 0.75 oz/cwt, about 1.0 oz/cwt, about 1.5 oz/cwt, about 2.0 oz/cwt, about 2.5 oz/cwt, about 3.0 oz/cwt, about 3.5 oz/cwt, about 4.0 oz/cwt, about 4.5 oz/cwt, about 5.0 oz/cwt, or about 0.2 oz/cwt or more, about 0.5 oz/cwt or more, about 0.75 oz/cwt or more, about 1.0 oz/cwt or more, about 1.5 oz/cwt or more, about 2.0 oz/cwt or more, about 2.5 oz/cwt or more, about 3.0 oz/cwt or more, about 3.5 oz/cwt or more, about 4.0 oz/cwt or more, about 4.5 oz/cwt or more, or about 5.0 oz/cwt or more. In yet another aspect, a composition described herein is applied to a seed in a manner sufficient to convey the desired property.

In an aspect, a composition described herein is applied to a seed in a single application step. In another aspect, a composition described herein is applied in multiple application steps. In yet another aspect, a composition described herein is applied in one, two, three or more application steps to a seed. In another aspect, a method described herein excludes multiple application steps. In an aspect, the methods described herein include a first sequential application of a treating agent described herein to a seed followed by a second application of lubricant composition described herein to a seed.

Seeds which can be treated by the methods described herein include, for example, seeds that are treated with insecticides, pesticides, or fungicides. Seeds may include any agricultural or vegetable seeds that are planted through a vacuum planter, including wherein talc may be used as a planter lubricant. In an aspect, the seed is selected from the group consisting of a corn seed, cotton seed, rice seed, sorghum seed, oat seed, rye seed, barley seed, soybean seed, vegetable seed, wheat seed, sugarbeat seed, sunflower seed, lettuce seed, and spinach seed. In an aspect, the seed is corn seed. Examples of corn seeds capable of being used in the methods described herein include, for instance, sweet corn (for example, zea mays convar. saccharata var. Rugosa), silver queen corn, golden bantam, early sunglow, indian corn, sugar corn, pole corn, field corn, dent corn, flint corn, flour corn, blue corn (for example, Zea mays amylacea), pop corn, and waxy corn.

Seeds may be treated with the described compositions by applying the compositions directly to the seed. In another embodiment, the seed may be treated indirectly, for example by treating the environment or habitat in which the seed is exposed to. Conventional treatment methods may be used to treat the environment or habitat including dipping, spraying, fumigating, chemigating, fogging, scattering, brushing on, shanking or injecting.

### Repelling, Controlling, or Directing Structure

In an aspect, the disclosure provides for a structure that disperses, is coated with, or treated with an insect repelling, controlling, and/or directing compound in an amount that is sufficient to repel, control, or direct an insect of interest according to embodiments of the disclosure.

In an aspect, a structure is any piece of material or machinery that disperses, is coated with, or treated with an insect repelling, controlling, and/or directing compound in an amount that is sufficient to repel, control, or direct an insect of interest according to embodiments of the disclosure. In another aspect, the structure is treated with a lubricant compound or composition described herein. In a non-limiting embodiment, a repelling, controlling, and/or directing compound is coated or applied to a tractor, farm machinery, and/or other equipment designed for planting or otherwise treating seeds, plants, or plant parts. The components attached or incorporated into a seeds a tractor, farm machinery, and/or other equipment designed for planting or otherwise treating seeds, plants, or plant parts can also be treated. In an aspect, a tractor, farm machinery, and/or other equipment designed for planting or otherwise treating seeds, plants, or plant parts can be treated with “strips” or “containers” that house sufficient amount of a repelling, controlling, or directing compound or composition described herein to selectively repel an insect of interest, such as a bee.

In another aspect, the mechanism or container responsible for planting or dispersing seed, for example, a hopper box or planter, is treated with a repelling, controlling, or directing compound or composition described herein. In another aspect, only the mechanism or container responsible for planting or dispersing seed, for example, a hopper box or planter, is treated with a repelling, controlling, or directing compound or composition described herein.

In an aspect, the structure, for example, the mechanism or container responsible for planting or dispersing seed is lined with “strips” of a substance that is treated with a repelling, controlling, and/or directing compound or composition herein. In another aspect, the “strips” are sticker-like and can be applied when and where it is desirable to repel, control, or direct an insect or interest, such as a bee. In yet another aspect, a repelling, controlling, and/or directing compound or composition herein is impregnated into the mechanism or container responsible for planting or dispersing seed or otherwise treated with a repelling, controlling, and/or directing compound or composition herein.

In yet another aspect, an additional machine that is separate from a tractor, farm machinery, and/or other equipment designed for planting or otherwise treating seeds, plants, or plant parts is treated or otherwise disperses a repelling, controlling, and/or directing compound or composition herein in an amount that selectively repels, controls, or directs an insect of interest, such as a bee, for the time and/or the distance described herein. In an aspect, the additional machine is a trailer.

In an aspect, the amount of a repelling, controlling, or directing compound or composition described herein used to treat a tractor, farm machinery, and/or other equipment involved in the planting and/or treatment of seeds, plants, or plant parts is higher (in weight percent) than the amount used to treat a seed, plant, or plant part thereof outside of using such equipment. In another aspect, the amount of a repelling, controlling, or directing compound or composition described herein used to treat a tractor, farm machinery, and/or other equipment involved in the planting and/or treatment of seeds, plants, or plant parts is at least about 1%, at least about 2%, at least about 2.5%, at least about 5%, at least about 7.5%, at least about 10%, at least about 20%, at least about 30%, at least about 40% by weight, at least about 50% by weight, or at least about 75% by weight of a composition.

In another aspect, the amount of a repelling, controlling, or directing compound or composition described herein used to treat a tractor, farm machinery, and/or other equipment involved in the planting and/or treatment of seeds, plants, or plant parts is at least at 0.1% to about 02%, about 0.5% to about 5%, about 3% to about 10%, about 5% to about 15%, about 10% to about 20%, about 20% to about 35%, about 10% to about 50%, about 25% to about 75%, or about 50% to about 80%, and about 95% or more by weight of a composition.

### Methods of Repelling, Controlling, or Directing an Insect

In an aspect, a compound or composition described herein repels, controls, or directs an insect of interest such that the insect is not in direct contact with a seed, plant part, plant, area, or other substance treated with a compound or composition described herein. In another aspect, a compound or composition described herein repels an insect of interest such that the insect is not in direct contact with pollen. In yet another aspect, a compound or composition described herein repels, controls, or directs an insect of interest such that the insect does not land and collect nectar.

In an aspect, the disclosure provides for a method of repelling, controlling, or directing an insect by utilizing a compound or composition described herein. In another aspect, the disclosure provides for a method of repelling, controlling, or directing an insect, or an insect of interest, for example a bee, by treating a seed, plant part, or plant with a compound or composition described herein.

In an aspect, a compound or composition described herein repels, controls, or directs all or a broad range of an insect of interest, for instance a bee. In another aspect, a compound or composition described herein repels, controls, or directs on a selective basis. In yet another aspect, the insect may be directed by coming into contact with a compound or composition described herein. In another aspect, an insect of interest, such as a bee, in a manner such that the insect is not in direct contact with a substance treated with the repellent, controlling, or directing compound or composition. In another aspect, a compound or composition described herein repels, controls, or directs an insect of interest, such as a bee, in a manner such that the insect has only minimal contact with a treated substance.

In an aspect, a compound or composition described herein repels, controls, or directs all or a broad range of an insect of interest, for instance a bee. In another aspect, a compound or composition described herein repels, controls, or directs on a selective basis. In yet another aspect, the insect may be directed by coming into contact with a compound or composition described herein. In another aspect, an insect of interest, such as a bee, in a manner such that the insect is not in direct contact with a substance treated with the repellent, controlling, or directing compound or composition. In another aspect, a compound or composition described herein repels, controls, or directs an insect of interest, such as a bee, in a manner such that the insect has only minimal contact with a treated substance.

In another aspect, a compound or composition described herein repels, controls, or directs an insect of interest such that the insect is not in direct contact with a treated substance for at least about 10 minutes, about 30 minutes, about 1 hour, about 4 hours, about 8 hours, about 12 hours, about 24 hours, about 2 days, about 3 days, about 7 days, about 14 days, about 21 days, about 1 month, about 2 months, or about 3 months or more. In yet another aspect, a compound or composition described herein repels, controls, or directs an insect of interest such that the insect is not in direct contact with a treated substance for a desired period of time, for example, a planting, growing, or harvesting season.

In another aspect, a compound or composition described herein repels, controls, or directs an insect of interest such that the insect is at least about 1 cm, at least about 5 cm, at least about 10 cm, at least about 100 cm, at least about 0.2 meters, at least about 0.5 meters, at least about 1 meter, at least about 2 meters, at least about 5 meters, at least about 10 meters, at least about 25 meters, at least about 50 meters, at least about 100 meters, at least about 200 meters, or at least about 300 meters or more away from a seed, plant part, plant, area, or other substance treated with a repelling, controlling, or directing compound or composition described herein. In yet another aspect, a compound or composition described herein repels an insect of interest such that the insect is at least about 1 cm, at least about 5 cm, at least about 10 cm, at least about 100 cm, at least about 0.2 meters, at least about 0.5 meters, at least about 1 meter, at least about 2 meters, at least about 5 meters, at least about 10 meters, at least about 25 meters, at least about 50 meters, at least about 100 meters, at least about 200 meters, or at least about 300 meters or more away from a seed, plant part, plant, area, or other substance treated with the repelling, controlling, or directing compound or composition described herein for at least about 10 minutes, about 30 minutes, about 1 hour, about 4 hours, about 8 hours, about 12 hours, about 24 hours, about 2 days, about 3 days, about 7 days, about 14 days, about 21 days, about 1 month, about 2 months, or about 3 months or more, or desired period of time, for example, a planting, growing, or harvesting season.

In another aspect, a compound or composition described herein repels, controls, or directs an insect of interest such that the insect is at least about 1 cm to about 10 cm, about 10 cm to about 100 cm, about 100 cm to about 500 cm, about 1 meter to about 5 meters, about 5 meters to about 10 meters, about 10 meters to about 50 meters, about 50 meters to about 100 meters, about 100 meters to about 250 meters, and about 250 meters to about 500 meters or more away from a seed, plant part, plant, area, or other substance treated with a compound or composition described herein. In yet another aspect, a compound or composition described herein repels an insect of interest in a manner such that the insect is at least about 1 cm to about 10 cm, about 10 cm to about 100 cm, about 100 cm to about 500 cm, about 1 meter to about 5 meters, about 5 meters to about 10 meters, about 10 meters to about 50 meters, about 50 meters to about 100 meters, about 100 meters to about 250 meters, and about 250 meters to about 500 meters or more away from a seed, plant part, plant, area, or other substance treated with a compound or composition described herein for at least about 10 minutes, about 30 minutes, about 1 hour, about 4 hours, about 8 hours, about 12 hours, about 24 hours, about 2 days, about 3 days, about 7 days, about 14 days, about 21 days, about 1 month, about 2 months, or about 3 months or more, or desired period of time, for example, a planting, growing, or harvesting season.

In another aspect, a compound or composition described herein controls or directs an insect of interest, such as a bee, for at least about 10 minutes, about 30 minutes, about 1 hour, about 4 hours, about 8 hours, about 12 hours, about 24 hours, about 2 days, about 3 days, about 7 days, about 14 days, about 21 days, about 1 month, about 2 months, about 3 months or more, or designated a planting, growing, or harvesting season.

In another aspect, one or more additional repellent, controlling, or directing compounds or compositions can be added to a repellency composition described herein in a manner that modifies or increases repellency via additive efforts, synergistic efforts, and combinations thereof. A compound or composition described herein can also be formulated in a delayed release formulation or controlled release formulation which can delay or control the release of the repelling compound or composition. In another aspect, a compound or composition described herein can also be formulated in a rapid release formulation which can expedite the release of the repelling, controlling, or directing compound or composition.

In an aspect, a method of “repelling” refers to the ability of a compound or composition described herein to influence or alter the behavior of an insect, for example, a bee, away from an area, location, structure, seed, plant, plant part, or substance of interest. In order to be classified as “repelling” according to an aspect of the disclosure, it is not necessary that 100% of the insects, pollinating insects, pests, or mites be directed away from an area, location, structure, seed, plant, plant part, or substance of interest. In yet another aspect, an insect is “repelled” if at least 50%, at least 75%, at least 90%, at least 95%, or at least 98% of the insects are directed away from an area, location, structure, seed, plant, plant part, or substance of interest.

In another aspect, a method of “directing” refers to the ability of a compound or composition described herein to influence the behavior or movement of an insect, for example a bee, in a given direction. In order to be classified as “directing” according to an aspect of the disclosure, it is not necessary that 100% of the insects, pests, or other animals be directed away from an area, location, structure, seed, plant, plant part, or substance of interest. In yet another aspect, an insect is “directed away” if at least 50%, at least 75%, at least 90%, at least 95%, or at least 98% of the insects are directed away from an area, location, structure, seed, plant, plant part, or substance of interest.

In an aspect, a method of “controlling” refers to the ability of a compound or composition described herein to control or alter the behavior of an insect, for example a bee. In order to be classified as “controlling” according to an aspect of the disclosure, it is not necessary that 100% of the insects, pests, or other animals be controlled away from an area, location, structure, seed, plant, or substance of interest. In yet another aspect, an insect is “controlled” if at least 50%, at least 75%, at least 90%, at least 95%, or at least 98% of the insect behavior is altered or controlled relative to an area, location, structure, seed, plant, or substance of interest.

In an aspect, a compound or composition described herein is applied, incorporated, or coated on a seed, plant part, or plant thereof.

### Repelling, Controlling, or Directing an Insect

In an aspect, a compound or composition described herein repels, controls, or directs an insect of interest such that the insect is not in direct contact with a seed, plant part, plant, area, or other substance treated with a compound or composition described herein. In another aspect, a compound or composition described herein repels an insect of interest such that the insect is not in direct contact with pollen. In yet another aspect, a compound or composition described herein repels, controls, or directs an insect of interest such that the insect does not land and collect nectar.

In another aspect, a compound or composition described herein repels, controls, or directs an insect of interest such that the insect is not in direct contact with a treated substance for at least about 10 minutes, about 30 minutes, about 1 hour, about 4 hours, about 8 hours, about 12 hours, about 24 hours, about 2 days, about 3 days, about 7 days, about 14 days, about 21 days, about 1 month, about 2 months, or about 3 months or more. In yet another aspect, a compound or composition described herein repels, controls, or directs an insect of interest such that the insect is not in direct contact with a treated substance for a desired period of time, for example, a planting, growing, or harvesting season.

In another aspect, a compound or composition described herein repels, controls, or directs an insect of interest such that the insect is at least about 1 cm, at least about 5 cm, at least about 10 cm, at least about 100 cm, at least about 0.2 meters, at least about 0.5 meters, at least about 1 meter, at least about 2 meters, at least about 5 meters, at least about 10 meters, at least about 25 meters, at least about 50 meters, at least about 100 meters, at least about 200 meters, or at least about 300 meters or more away from a seed, plant part, plant, area, or other substance treated with a repelling, controlling, or directing compound or composition described herein. In yet another aspect, a compound or composition described herein repels an insect of interest such that the insect is at least about 1 cm, at least about 5 cm, at least about 10 cm, at least about 100 cm, at least about 0.2 meters, at least about 0.5 meters, at least about 1 meter, at least about 2 meters, at least about 5 meters, at least about 10 meters, at least about 25 meters, at least about 50 meters, at least about 100 meters, at least about 200 meters, or at least about 300 meters or more away from a seed, plant part, plant, area, or other substance treated with the repelling, controlling, or directing compound or composition described herein for at least about 10 minutes, about 30 minutes, about 1 hour, about 4 hours, about 8 hours, about 12 hours, about 24 hours, about 2 days, about 3 days, about 7 days, about 14 days, about 21 days, about 1 month, about 2 months, or about 3 months or more, or desired period of time, for example, a planting, growing, or harvesting season.

In another aspect, a compound or composition described herein repels, controls, or directs an insect of interest such that the insect is at least about 1 cm to about 10 cm, about 10 cm to about 100 cm, about 100 cm to about 500 cm, about 1 meter to about 5 meters, about 5 meters to about 10 meters, about 10 meters to about 50 meters, about 50 meters to about 100 meters, about 100 meters to about 250 meters, and about 250 meters to about 500 meters or more away from a seed, plant part, plant, area, or other substance treated with a compound or composition described herein. In yet another aspect, a compound or composition described herein repels an insect of interest in a manner such that the insect is at least about 1 cm to about 10 cm, about 10 cm to about 100 cm, about 100 cm to about 500 cm, about 1 meter to about 5 meters, about 5 meters to about 10 meters, about 10 meters to about 50 meters, about 50 meters to about 100 meters, about 100 meters to about 250 meters, and about 250 meters to about 500 meters or more away from a seed, plant part, plant, area, or other substance treated with a compound or composition described herein for at least about 10 minutes, about 30 minutes, about 1 hour, about 4 hours, about 8 hours, about 12 hours, about 24 hours, about 2 days, about 3 days, about 7 days, about 14 days, about 21 days, about 1 month, about 2 months, or about 3 months or more, or desired period of time, for example, a planting, growing, or harvesting season.

In another aspect, a compound or composition described herein controls or directs an insect of interest, such as a bee, for at least about 10 minutes, about 30 minutes, about 1 hour, about 4 hours, about 8 hours, about 12 hours, about 24 hours, about 2 days, about 3 days, about 7 days, about 14 days, about 21 days, about 1 month, about 2 months, about 3 months or more, or designated a planting, growing, or harvesting season.

In another aspect, one or more additional repellent, controlling, or directing compounds or compositions can be added to a repellency composition described herein in a manner that modifies or increases repellency via additive efforts, synergistic efforts, and combinations thereof. A compound or composition described herein can also be formulated in a delayed release formulation or controlled release formulation which can delay or control the release of the repelling compound or composition. In another aspect, a compound or composition described herein can also be formulated in a rapid release formulation which can expedite the release of the repelling, controlling, or directing compound or composition.

In yet another aspect, a compound or composition described herein is applied to a border or outer edge of a field, location, structure or dwelling or portions thereof. In another aspect, a compound or composition described herein is applied to the border or outer edge of a field or area or portion thereof prior to the application of seed to a field, at the time of seed planting, after seed planting, or combinations thereof. In another aspect, the seed is applied to a field or area by a mechanized planter, such as a tractor. In yet another aspect, a compound or composition described herein, such as a repelling, controlling, or directing compound or composition is dispersed via a tractor at the same time seed is planted, before seed is planted, after seed is planted, or combinations thereof. In another aspect, the field or area is not been tilled prior to seed application. In yet another aspect, the field has not been tilled for about 10 minutes to about 24 hours, about 1 hour to about 8 hours, about 24 hours to about 48 hours, about 24 hours to about one month, or about one month or more prior to application of a compound or composition described herein. The field or area may also contain vegetation, such a weeds, crops, or dandelions, prior to application of a compound or composition described herein. By applying a compound or composition described herein, such as a repelling, directing, or controlling compound, to a boarder or outer edge of a field or area, a zone or buffer can be created to keep an insect of interest, such as a bee, from penetrating the zone or buffer.

In another aspect, a compound or composition described herein is applied to the interior portion of an area or field. In another aspect, the field or area is cleared, for example by application of an herbicide, prior to seed planting. In yet another aspect, the field or area is treated with a herbicide for about 10 minutes to about 24 hours, about 1 hour to about 8 hours, about 24 hours to about 48 hours, about 72 hours to about one month, or about one month or more prior to application of a compound or composition described herein.

In an aspect, the percent of the compound on any composition or formulation is determined by the interplay of the effectiveness in the compound repellency, the medium or other components in which the compound is carried, the methods of application and the area that is being treated, when in terms of surface area or volume. For example, where the surface is a flat plate or wall, surface area may be used, and where the area is a room or other space, volume may be used to determine rates of applications.

In an aspect, a method of “repelling” refers to the ability of a compound or composition described herein to influence or alter the behavior of an insect, for example, a bee, away from an area, location, structure, seed, plant, plant part, or substance of interest. In order to be classified as “repelling” according to an aspect of the disclosure, it is not necessary that 100% of the insects, pollinating insects, pests, or mites be directed away from an area, location, structure, seed, plant, plant part, or substance of interest. In yet another aspect, an insect is “repelled” if at least 50%, at least 75%, at least 90%, at least 95%, or at least 98% of the insects are directed away from an area, location, structure, seed, plant, plant part, or substance of interest.

In another aspect, a method of “directing” refers to the ability of a compound or composition described herein to influence the behavior or movement of an insect, for example a bee, in a given direction. In order to be classified as “directing” according to an aspect of the disclosure, it is not necessary that 100% of the insects, pests, or other animals be directed away from an area, location, structure, seed, plant, plant part, or substance of interest. In yet another aspect, an insect is “directed away” if at least 50%, at least 75%, at least 90%, at least 95%, or at least 98% of the insects are directed away from an area, location, structure, seed, plant, plant part, or substance of interest.

In an aspect, a method of “controlling” refers to the ability of a compound or composition described herein to control or alter the behavior of an insect, for example a bee. In order to be classified as “controlling” according to an aspect of the disclosure, it is not necessary that 100% of the insects, pests, or other animals be controlled away from an area, location, structure, seed, plant, or substance of interest. In yet another aspect, an insect is “controlled” if at least 50%, at least 75%, at least 90%, at least 95%, or at least 98% of the insect behavior is altered or controlled relative to an area, location, structure, seed, plant, or substance of interest.

In an aspect, a compound or composition described herein is applied, incorporated, or coated on a seed, plant part, or plant thereof.

### Compositions

In an aspect, the amount of a repelling, controlling, or directing compound or composition described herein can be an amount that is effective (“effective amount”) to repel, control, or direct the movement of an insect of interest. In another aspect, the amount of a repelling, controlling, or directing compound or composition described herein can be an amount that is effective (“effective amount”) to reduce or mitigate the influence of a substance that is harmful to an insect of interest.

In another aspect, a composition comprises a repelling, controlling, or directing compound or composition in at least about 0.01%, at least about 0.025%, at least about 0.05%, at least about 0.1%, at least about 0.25%, at least about 0.5%, at least about 1%, at least about 2% at least about 2.5%, at least about 5%, at least about 7.5%, at least about 10%, at least about 25%, or at least about 50%, by weight of a composition. In yet another aspect, a composition comprises a repelling, controlling, or directing compound or composition is no more than about 0.01%, no more than about 0.025%, no more than about 0.05%, no more than about 0.1%, no more than about 0.25%, no more than about 0.5%, no more than about 1%, no more than about 2.0%, no more than about 2.5%, no more than about 5%, no more than about 7.5%, no more than about 10%, no more than about 25%, no more than about 50%, by weight of a composition.

In another aspect, a compound or composition described herein comprises a repelling, controlling, or directing compound or composition at 0.001% to about 0.1%, about 0.025%, about 0.0025% to about 0.25%, about 0.1% to about 1%, about 0.1% to about 2.5%, about 0.5% to about 2.5%, about 1% to about 2%, about 1% to about 3%, about 1% to about 5%, about 1% to about 10%, about 2% to about 10%, about 5% to about 10%, about 5% to about 20%, about 10% to about 25%, about 10% to about 50%, about 25% to about 50%, or about 20% to about 80%, and about 95% or more by weight of a composition.

In another aspect, a composition described herein comprises an insecticide, herbicide, or fungicide, or other compound described herein in at least about 0.01%, at least about 0.025%, at least about 0.05%, at least about 0.1%, at least about 0.25%, at least about 0.5%, at least about 1%, at least about 2% at least about 2.5%, at least about 5%, at least about 7.5%, at least about 10%, at least about 25%, or at least about 50%, by weight of a composition. In yet another aspect, a composition comprises a repelling, controlling, or directing compound or composition in no more than about 0.01%, no more than about 0.025%, no more than about 0.05%, no more than about 0.1%, no more than about 0.25%, no more than about 0.5%, no more than about 1%, no more than about 2.0%, no more than about 2.5%, no more than about 5%, no more than about 7.5%, no more than about 10%, no more than about 25%, no more than about 50%, by weight of a composition.

In yet another aspect, a composition described herein comprises a insecticide, herbicide, fungicide, or other compound described herein at 0.001% to about 0.1%, about 0.025%, about 0.0025% to about 0.25%, about 0.1% to about 1%, about 0.1% to about 2.5%, about 0.5% to about 2.5%, about 1% to about 2%, about 1% to about 3%, about 1% to about 5%, about 1% to about 10%, about 2% to about 10%, about 5% to about 10%, about 5% to about 20%, about 10% to about 25%, about 10% to about 50%, about 25% to about 50%, or about 20% to about 80%, and about 95% or more by weight of a composition.

In another aspect, a repelling, controlling, or directing compound or composition described herein is formulated with insecticidal, herbicidal, fungicide, insect regulator, plant growth regulator, plant growth regulator for crop protection, insect growth regulator, and pest control agents, such as household pest control agents.

In an aspect, the disclosure provides for a composition comprising, consisting of, or consisting essentially of one or more repelling, controlling, or directing compounds or compositions disclosed herein. In another aspect, the disclosure provides for a composition comprising, consisting of, or consisting essentially of a single repelling, controlling, or directing compound or composition disclosed herein. In yet another aspect, the disclosure provides for a composition comprising, consisting of, or consisting essentially of two, three, four, or five or more repelling, controlling, or directing compounds or compositions. In another aspect, the disclosure provides for a composition comprising, consisting of, or consisting essentially of no more than two, no more than three, no more than four, or no more than five or more repelling, controlling, or directing compounds or compositions.

In an aspect, a compound or composition described herein is formulated as a foliar composition, a foliar spray, solutions, emulsions, suspension, coating formulation, non-pesticidal or pesticidal coating formulation, encapsulated formulation, solid, liquid, fertilizer, paste, granule, powder, suspension, or suspension concentrate. In another aspect, a compound or composition described herein may be employed alone or in solid, dispersant, or liquid formulation. In yet another aspect, a compound or composition described herein is formulated as a tank-mix product.

In another aspect, a compound or composition described herein can take any of a variety of dosage forms including, without limitation, suspension concentrates, aerosols, capsule suspensions, cold-fogging concentrates, warm-fogging concentrates, encapsulated granules, fine granules, flowable concentrates for the treatment of seed, ready-to-use solutions, dustable powders, emulsifiable concentrates, oil-in-water emulsions, water-in-oil emulsions, macrogranules, microgranules, oil-dispersible powders, oil-miscible flowable concentrates, oil-miscible liquids, foams, pastes, pesticide-coated seed, suspoemulsion concentrates, soluble concentrates, suspensions, wettable powders, soluble powders, dusts and granules, water-soluble granules or tablets, water-soluble powders for the treatment of seed, wettable powders, natural products and synthetic substances impregnated with a compound or composition described herein, a net impregnated with a compound or composition described herein, and also microencapsulations in polymeric substances and in coating materials for seed, and also ULV cold-fogging and warm-fogging formulations.

In another aspect, a seed is coated, encapsulated or otherwise covered with one or more repelling, controlling, or directing compounds or compositions described herein. In yet another aspect, a seed is coated, encapsulated or otherwise covered with one or more repelling, controlling, or directing compounds and one or more insecticides, pesticides, fungicides, fertilizers of a micronutrient or macronutrient nature, herbicides, feeding inhibitors, insect molting, insect mating, insect maturation inhibitors, nematocides, nutritional or horticultural supplements, or larvicides. In another aspect, a compound or composition described herein is formulated to repel, control, or direct an insect, for example a bee, from a seed. In another aspect, a compound or composition described herein is formulated to repel an insect, for example a bee, from a seed and therefore from a field, yard, pot, area, bush, tree, or body of water onto which the seeds are intentionally or unintentionally present as well as provide an additional beneficial or otherwise useful effect.

In another aspect, a compound or composition disclosed herein may optionally include one or more additional compounds providing an additional beneficial or otherwise useful effect. Such compounds include, without limitation, an adhesive, a solvent, a surfactant, a wetting agent, an emulsifying agent, a carrier, adjuvant, a diluent, a dispersing agent an insecticide, a pesticide, a fungicide, a fertilizer of a micronutrient or macronutrient nature, a herbicide, a feeding inhibitor, an insect molting inhibitor, an insect mating inhibitor, an insect maturation inhibitor, a nematocide, a nutritional or horticultural supplement, or any combination thereof. In an aspect, a composition described herein is odor free. In another aspect, the surfactant is Genapol, for example Genapol X-080.

In another aspect, compounds or compositions described herein can be combined with a fertilizer. Examples of fertilizers capable of being used with the compositions and methods described herein include, for example, Urea, Ammonium Nitrate, Ammonium Sulfate, Calcium Nitrate, Diammonium Phosphate, Monoammonium phosphate, Triple Super Phosphate, Potassium Nitrate, Potassium nitrate, nitrate of potash, Potassium Chloride, muriate of potash, di and mono potassium salts of phosphite/phosphonate.

In another aspect, the disclosure provides for a fertilizer composition combined with at least one repelling, controlling, or directing compound or composition from Formula I-IX or compounds 1-33 in Table 1.

The disclosure also provides for bait composition comprising a compound or composition described herein. In another aspect, the disclosure provides for bait composition comprising a repelling, controlling, or directing compound or composition described herein. The bait composition comprising a repelling, controlling, or directing compound or composition described herein and may be used in any of the methods described herein and may optionally include another active ingredient, such as an insecticide, herbicide, or pesticide.

In an aspect, an insect repelling, controlling, or directing compound or composition is combined with a compound or composition that alters the olfactory senses, sight, chemosensory senses, or other physical characteristics of an insect. In another aspect, an insect repelling compound or composition described herein can be combined with a compound or composition that alters the behavior of an insect by color, taste, or additional feature that has the ability to influence the senses of an insect.

In an aspect, a composition or method described herein includes an inorganic lubricant composition. In another aspect, a composition or method described herein does not include an inorganic lubricant composition. Inorganic compounds, for example talc and graphite, encompass compounds such as carbides, carbonates, simple oxides of carbon, cyanides, and allotropes of carbon.

In an aspect, a repelling, controlling, or directing compound or composition described herein is combined with a talc and/or graphite. In another aspect, a repelling, controlling, or directing compound or composition described herein is combined with talc and/or graphite and an active agent compound or composition, for example, an insecticide, pesticide, fungicide, or herbicide. In another aspect, (1) the talc and/or graphite, (2) repelling, controlling, or directing compound or composition, and (3) an active agent are added to a hopper box or planter together, separately, or combinations thereof. In another aspect, seed is added to the hopper or planter with the composition combination. In yet another aspect, seed pre-treated with an active agent composition is added to the hopper and/or planter and a talc and/or graphite composition is added together with a repelling, controlling, or directing compound or composition described herein.

In an aspect, a composition or method described herein does not include talc. In another aspect, a composition or method described herein does not include graphite or graphite blends. In yet another aspect, a composition or method described herein does not include blends of graphite and/or talc. In another aspect, a composition or method described herein contains trace amount of talc or graphite. In another aspect, a composition or method described herein contains less than about 5%, less than about 10%, less than about 20%, less than about 20%, less than about 30%, less than about 40%, or less than about 50% by weight of talc, graphite, or a combination of talc or graphite.

### Repelling, Controlling, or Directing Insects

In an aspect, the insect can be a pollinating insect. In another aspect, the insect is a repelled, controlled, or directed non-pollinating insect.

In another aspect, the insect can be an insect capable of being influenced by the presence of a pesticide, fungicide, herbicidal, or insecticide. In another aspect, the insect can be an insect capable of being influenced by the presence of a pesticide, fungicide, herbicidal, or insecticide dust.

In an aspect, the insect is of the order Order Hymenoptera. In yet another aspect, the insect is a bee. In another aspect, the bee is a honey bee (Apis). In another aspect, the bee is a European honey bee (Apis mellifera) or Africanized honey bee. Examples of common bees are bumble bees (Bomzbus), small carpenter bees (Ceratina), large carpenter bees (Xylocopa), paper wasps (Polistes), yellow jackets (Vespula), and baldfaced hornets (Vespula). As used herein, the term “honey bee” can refer to any member of the Order Hymeoptera, Family Apidae, and includes, without limitation, Apis andreniformis, Apis cerana, Apis dorsata, Apis florae, Apis mellifera, Apis koschevnikovi, Apis laboriosa, Apis nigrocincta, Apis rorea, subspecies thereof, and strains, varieties, and hybrids thereof.

In yet another aspect, the insect is a butterfly. Butterflies are insects of the Order Lepidoptera. In an aspect, a butterfly is a true butterfly (superfamily Papilionoidea), a skipper (superfamily Hesperioidea), or a moth-butterflies (superfamily Hedyloidea). Examples of common butterflies are Swallowtails and Birdwings (Family Papilionidae) such as Common Yellow Swallowtail (Papilio machaon), Spicebush Swallowtail (Papilio Troilus), Lime Butterfly (Papilio demoleus), the Ornithoptera genus, the Whites and Yellows (Family Pieridae), such as Small White (Pieris rapae), Green-veined White (Pieris napi), Common Jezebel (Delias eucharis), the Blues and Coppers or Gossamer-Winged Butterflies (Family Lycaenidae) such as Red Pierrot (Talicada nyseus), Metalmark butterflies (Family Riodimidae) such as Duke of Burgundy (Hamearis lucina), Plum Judy, (Abisara echerius), the Brush-footed butterflies (Family Nymphalidae) such as Painted Lady, or Cosmopolitan (Vanessa cardui), Monarch butterfly (Danaus plexippus), Morpho genus, Speckled Wood (Pararge aegeria), Skippers (Family Hesperiidae) such as Mallow Skipper (Carcharodus alceae), and Zabulon Skipper (Poanes zabulon).

In another aspect, an insect described herein is an ant. In yet another aspect, the ant is a carpenter ant, a fire ant, a pharaoh ant, a ghost ant, and a black ant.

The disclosure refers to “insects” for simplicity of discussion, but it is to be understood that the present is not so limited. The present disclosure may be utilized to selectively direct, repel and/or control any organism that responds to the compounds or compositions of the present invention, and to any analogues or similar compounds and/or composition thereof that may be expected to have a similar influence on the insect or other organism. Also, the discussion in many cases hereinafter will refer to an “insect of interest” and, unless otherwise clear from the context of its use elsewhere herein, the phrase will be used to refer to the aspect of the present invention that allows for selective controlling, directing or repelling a particular subset of insects or other organisms. In other words, where the user of the present invention desires to control, direct or repel a subset of organisms such as insects, while not directing, controlling or repelling others, the subset of insects being controlled, directed and/or repelled becomes and is referred to as the “insect(s) of interest.”

In another aspect, a compound or composition described herein selectively repels, directs, controls, or alters the behavior of an insect, for example a bee. In yet another aspect, a compound or composition described herein selectively repels, directs, or controls, or alters the behavior of a honey bee, for example, any member of the Order Hymeoptera, Family Apidae, and includes, without limitation, Apis andreniformis, Apis cerana, Apis dorsata, Apis florae, Apis mellifera, Apis koschevnikovi, Apis laboriosa, Apis nigrocincta, Apis rorea, subspecies thereof, and strains, varieties, and hybrids thereof.

In another aspect, a compound or composition described herein selectively repels, directs, controls, or alters the behavior of one type or subset of insects, for example a bee, while not affecting other insects. For instance, in one embodiment, a repelling, controlling, or directing compound or composition is associated with an insecticidal composition, for example, by a combination of the repelling, controlling, or directing compound or composition together with an insecticidal composition. In another aspect, a repelling, controlling, or directing compound or composition is sequentially applied at the same time, prior to, or after an insecticidal composition to, for example, an area, seed, plant part, or plant. In yet another aspect, an attractant compound or composition is applied to a different area or substance aimed at attracting an insect of interest.

As a non-limiting example, (1) 2-decanone as the repelling, controlling, or directing compound is used to treat field, yard, or structure, (2) clothianidin as the insecticidal compound, and (3) sucrose as the attractant compound or composition are used to treat a field, yard, or structure. As an example, all or a first portion of a field, yard, or structure is treated with (1) 2-decanone and (2) clothianidin, while the remaining section of the field, yard, or structure or a second or more portion of a field, yard, or structure is treated with an attractant compound or composition, such as (3) sucrose. Under such a scenario, an insect that is targeted for repelling, controlling, or directing, such as a honeybee, would be selectively repelled, controlled, or directed by the repelling, controlling, or directing compound, in this case the (1) 2-decanone and (2) clothianidin composition/combination, while being simultaneously attracted or drawn to the attractant compound or composition, in this case (3) sucrose. Such a procedure would allow for the selective repulsion or control of an insect of interest, for example a honeybee, while at the same time allowing for the insecticide, in this case clothianidin, to treat any unwanted insects or pests. As such, the honeybee would be selectively repelled, controlled, or directed away from the (1) 2-decanone and (2) clothianidin composition/combination, drawn to the (3) sucrose, while the infestation of any remaining insects or pests is addressed.

As another non-limiting example, compounds, compositions, and methods described herein can be utilized in the following scenario.

For example, in one embodiment of the present disclosure, a vacuum planter is used to plant corn seed in a large field in a typical farming operation. The corn seed is genetically modified to tolerate a glufosinate-based herbicide, and the corn seed is coated with a clothanidin/bacillus firmus seed treatment (e.g. the PONCHO/VOTIVO seed treatment available from Bayer CropScience LP.) The novel lubricant of the present invention is added to a seed hopper on the vacuum planter by scooping it into the seed hopper in a powder form, to provide fluency and lubricity for the corn seeds during the planting operation, but with the desirably reduced dusting associated with the novel lubricant. An insect controlling, directing and repelling composition of the Formulas I-IX, (for example 2 decanone in particular), that selectively repels honey bees is provided in a powder form as a separate composition to be incorporated at or about the time and generally in the same manner that the novel lubricant, e.g., via scooping it into the seed hopper. In an optional embodiment of the present invention, the corn seeds are also coated with an insect controlling, directing and repelling compound at or about the time they are treated with the PONCHO/VOTIVO seed treatment. Also, in an optional embodiment of the present invention, the exhaust mechanism of the vacuum planter is fitted with a mechanism that allows for dispersion of the insect controlling, directing and repelling composition into the vacuum planter's exhaust at a variable rate that is selectable by the operator of the vacuum planter. Also, optionally in this embodiment of the present invention, an adjoining field containing wild flowers is treated with an attractant that operates to attract honey bees to the adjoining field.

When these embodiments of the disclosure are employed, including those that are optional, several benefits are apparent. As a starting point, dusting is reduced or eliminated with the novel lubricant. To the extent any dusting is not eliminated and develops from the corn seeds abrading against each other during planting, with the repellent composition present on the seeds, it will be abraded to and will be included in any dust that is formed and exhausted from the planter. And should more repellent composition be required or desired, the operator of the planter will selectively introduce additional repellent composition into the exhaust stream when and where it is needed.

The result is that honey bees are selectively repelled from the field where planting occurs, and are simultaneously drawn by the attractant to the neighboring field containing the wild flowers. Because the repellant composition is selective for honey bees, the PONCHO/VOTIVO seed treatment remains effective to control other insects and nematodes in the manner described on its label instructions.

### Kit

In another aspect, the disclosure provides for a kit comprising, consisting essentially of, or consisting of any of the compositions disclosed herein. In an aspect, the kit includes any of the combination of compositions described in Examples 1-9, Tables 1-12, or FIGS. 1-14. In another aspect, the kit provides for the compositions described in Examples 1-9, Tables 1-12, or FIGS. 1-14, applied in a manner that is consistent with the methodology of these examples and figures. In another aspect, the kit provides instructions or guidance regarding the use of the compositions or methods described herein.

In an aspect, the kit includes instructions describing the methodology described herein. In another aspect, the kit includes instructions describing the methodology set forth in any of Examples 1-9, Tables 1-12, or FIGS. 1-14. In an aspect, the instructions are included with the kit, separate from the kit, in the kit, or are included on the kit packaging. In yet another aspect, the instructions provide for application of a lubricant composition at planting.

The following examples serve to illustrate certain aspects of the disclosure and are not intended to limit the disclosure.

### EXAMPLES

### Example 1

Example 1 sets forth Poncho/VOTiVO Corn dust levels with polyethylene wax as a planter lubricant.

In Table 1, the total grams of dust per 100,000 kernels and grams of clothianidin in total dust per 100,000 kernels for seeds treated with Poncho/VOTiVO and fluency powder (polyethylene wax) as a planter lubricant were evaluated. As set forth in Table 1, a treatment combination of Poncho/VOTiVO and talc treatment was compared to a treatment combination of Poncho/VOTiVO and fluency powder (polyethylene wax) at 0.56 oz/cwt seed, 0.75 oz/cwt seed, 1.5 oz/cwt seed, and 3 oz/cwt seed. The dust and clothianidin exposure were measured with a Heubach Dustmeter. The data in Table 1 represents an average of two seed sources.

In FIG. 2, the % Singulation, % Population, % Skips, and % Multiples were evaluated on a treatment combination of Poncho/VOTiVO and talc treatment as compared to a treatment combination of Poncho/VOTiVO and fluency powder (polyethylene wax) at 0.56 oz/cwt seed, 0.75 oz/cwt seed, 1.5 oz/cwt seed, and 3 oz/cwt seed. As set forth in FIG. 2, the % Singulation (the percentage of single distributed seeds spaced and planted in a manner that is consistent with the planter specification) and % Population (the number, in percent, of desired seeds that were planted in a manner that is consistent with the planter specification) of seeds coated with polyethylene wax as a lubricant were in line with those with as compared to talc. Additionally, as set forth in FIG. 2, the % Skips (the percentage of seeds that were not planted in a manner that is consistent with the planter specification) and the % Multiples (the percentage of multiple planted seeds) of seeds coated with an oxidized polyethylene wax as a lubricant were also in line with those with as compared to talc.

TABLE 1

| | | Grams | |
|---|---|---|---|
| | | clothianidin in | |
| | Total Grams | total dust per | % decrease |
| | dust per | 100,000 kernels | of clothianidin |
| Treatment & Planter | 100,000 | (HPLC analysis | in dust |
| Lubricant | kernels | of filters) | versus Talc |
| Poncho/VOTiVO | 0.21 | 0.04 | −76% |
| (no lubricant) | | | |
| Poncho/VOTiVO with | 5.21 | 0.16 | Control |
| Talc at 3.95 oz/cwt | | | |
| seed | | | |
| Poncho/VOTiVO with | 0.20 | 0.03 | −84% |
| Fluency Powder at | | | |
| 0.56 oz/cwt seed | | | |
| Poncho/VOTiVO with | 0.10 | 0.02 | −88% |
| Fluency Powder at | | | |
| 0.75 oz/cwt seed | | | |
| Poncho/VOTiVO with | 0.17 | 0.02 | −89% |
| Fluency Powder at | | | |
| 1.5 oz/cwt seed | | | |
| Poncho/VOTiVO with | 0.41 | 0.02 | −86% |
| Fluency Powder at | | | |
| 3 oz/cwt seed | | | |

In Table 2, the total grams of dust per 100,000 kernels and grams of clothianidin in total dust per 100,000 kernels for seeds treated with Poncho/VOTiVO and fluency powder (polyethylene wax) as a planter lubricant were evaluated. As set forth in Table 2, a treatment combination of Poncho/VOTiVO and talc treatment was compared to a treatment combination of Poncho/VOTiVO and fluency powder (oxidized polyethylene wax) at 0.56 oz/cwt seed, 0.75 oz/cwt seed, 1.5 oz/cwt seed, and 3 oz/cwt seed. The dust and clothianidin exposure were measured with a John Deere Vacuum Meter. The data in Table 2 represents an average of two seed sources. The data was measured by dust captured in the vacuum air stream coming out of the meter on the test stand.

In an aspect, a repelling, controlling, or directing compound or composition described herein is added to a planter lubricant, for example, in the methods and compositions described in Tables 1 and 2. Such a composition has the ability to reduce dust emission while repelling, controlling, or directing insects.

TABLE 2

| | | Grams | |
|---|---|---|---|
| | | clothianidin in | |
| | Total Grams | total dust per | % decrease |
| | dust per | 100,000 kernels | of clothianidin |
| Treatment & Planter | 100,000 | (HPLC analysis | in dust |
| Lubricant | kernels | of filters) | versus Talc |
| Poncho/VOTiVO | 0.89 | 0.09 | −19% |
| (no lubricant) | | | |
| Poncho/VOTiVO with | 4.21 | 0.11 | Control |
| Talc at 3.95 oz/cwt | | | |
| seed | | | |
| Poncho/VOTiVO with | 0.45 | 0.03 | −69% |
| Fluency Powder at | | | |
| 0.56 oz/cwt seed | | | |
| Poncho/VOTiVO with | 0.29 | 0.02 | −78% |
| Fluency Powder at | | | |
| 0.75 oz/cwt seed | | | |
| Poncho/VOTiVO with | 0.63 | 0.04 | −64% |
| Fluency Powder at | | | |
| 1.5 oz/cwt seed | | | |
| Poncho/VOTiVO with | 0.78 | 0.03 | −73% |
| Fluency Powder at | | | |
| 3 oz/cwt seed | | | |

### Example 2

Example 2 sets forth the Poncho 1250+VOTiVO Corn dust levels with polyethylene wax as a planter lubricant.

In Table 3, the total grams of dust per 100,000 kernels and grams of clothianidin in total dust per 100,000 kernels for seeds treated with Poncho 1250+VOTiVO and fluency powder (polyethylene wax) as a planter lubricant were evaluated. As set forth in Table 3, a treatment combination of Poncho 1250+VOTiVO and talc treatment was compared to a treatment combination of Poncho 1250+VOTiVO and fluency powder (polyethylene wax) at 0.56 oz/cwt seed, 0.75 oz/cwt seed, 1.5 oz/cwt seed, and 3 oz/cwt seed. The dust and clothianidin exposure were measured with a Heubach Dustmeter. The data in Table 3 represents an average of two seed sources.

In FIG. 4, the % Singulation, % Population, % Skips, and % Multiples were evaluated on a treatment combination of Poncho 1250+VOTiVO and talc treatment was compared to a treatment combination of Poncho 1250+VOTiVO and fluency powder (polyethylene wax) at 0.56 oz/cwt seed, 0.75 oz/cwt seed, 1.5 oz/cwt seed, and 3 oz/cwt seed. As set forth in FIG. 4, the % Singulation, % Population, % Skips, and % Multiples of seeds coated with polyethylene wax as a lubricant were in line with those with as compared to talc.

TABLE 3

| | | Grams | |
|---|---|---|---|
| | | clothianidin in | |
| | Total Grams | total dust per | % decrease |
| | dust per | 100,000 kernels | of clothianidin |
| Treatment & Planter | 100,000 | (HPLC analysis | in dust |
| Lubricant | kernels | of filters) | versus Talc |
| Poncho 1250 + | 0.18 | 0.03 | −85% |
| VOTiVO (no | | | |
| lubricant) | | | |
| Poncho 1250 + | 5.23 | 0.18 | Control |
| VOTiVO with Talc at | | | |
| 3.95 oz/cwt seed | | | |
| Poncho 1250 + | 0.06 | 0.01 | −95% |
| VOTiVO with Fluency | | | |
| Powder at 0.56 oz/cwt | | | |
| seed | | | |
| Poncho 1250 + | 0.07 | 0.01 | −96% |
| VOTiVO with Fluency | | | |
| Powder at 0.75 oz/cwt | | | |
| seed | | | |
| Poncho 1250 + | 0.10 | 0.01 | −94% |
| VOTiVO with Fluency | | | |
| Powder at 1.5 oz/cwt | | | |
| seed | | | |
| Poncho 1250 + | 0.09 | 0.01 | −93% |
| VOTiVO with Fluency | | | |
| Powder at 3 oz/cwt | | | |
| seed | | | |

In Table 4, the total grams of dust per 100,000 kernels and grams of clothianidin in total dust per 100,000 kernels for seeds treated with Poncho 1250+VOTiVO and fluency powder (oxidized polyethylene wax) as a planter lubricant were evaluated. As set forth in Table 4, a treatment combination of Poncho 1250+VOTiVO and talc treatment was compared to a treatment combination of Poncho 1250+VOTiVO and fluency powder (oxidized polyethylene wax) at 0.56 oz/cwt seed, 0.75 oz/cwt seed, 1.5 oz/cwt seed, and 3 oz/cwt seed. The dust and clothianidin exposure were measured with a John Deere Vacuum Meter. The data in Table 4 represents an average of two seed sources.

In an aspect, a repelling, controlling, or directing compound or composition described herein is added to a planter lubricant, for example, in the methods and compositions described in Tables 3 and 4. Such a composition has the ability to reduce dust emission while repelling, controlling, or directing insects.

TABLE 4

| | | Grams | |
|---|---|---|---|
| | | clothianidin in | % decrease |
| | Total Grams | total dust per | or increase |
| | dust per | 100,000 kernels | of clothianidin |
| Treatment & Planter | 100,000 | (HPLC analysis | in dust |
| Lubricant | kernels | of filters) | versus Talc |
| Poncho 1250 + | 0.77 | 0.13 | +7% |
| VOTiVO (no | | | |
| lubricant) | | | |
| Poncho 1250 + | 3.23 | 0.12 | Control |
| VOTiVO with Talc at | | | |
| 3.95 oz/cwt seed | | | |
| Poncho 1250 + | 0.41 | 0.04 | −63% |
| VOTiVO with Fluency | | | |
| Powder at 0.56 oz/cwt | | | |
| seed | | | |
| Poncho 1250 + | 0.21 | 0.03 | −78% |
| VOTiVO with Fluency | | | |
| Powder at 0.75 oz/cwt | | | |
| seed | | | |
| Poncho 1250 + | 0.44 | 0.04 | −70% |
| VOTiVO with Fluency | | | |
| Powder at 1.5 oz/cwt | | | |
| seed | | | |
| Poncho 1250 + | 0.61 | 0.03 | −73% |
| VOTiVO with Fluency | | | |
| Powder at 3 oz/cwt | | | |
| seed | | | |

### Example 3

Example 1 sets forth the Poncho/VOTiVO Corn dust levels with polyethylene wax as a planter lubricant.

In Table 5, the total grams of dust per 100,000 kernels and grams of clothianidin in total dust per 100,000 kernels for seeds treated with Poncho/VOTiVO and fluency powder (polyethylene wax) as a planter lubricant were evaluated. As set forth in Table 5, a treatment combination of Poncho/VOTiVO and graphite treatment was compared to a treatment combination of Poncho/VOTiVO and fluency powder (oxidized polyethylene wax) at 0.56 oz/cwt seed, 0.75 oz/cwt seed, 1.5 oz/cwt seed, and 3 oz/cwt seed. The dust and clothianidin exposure were measured with a Heubach Dustmeter. The data in Table 5 represents an average of two seed sources.

In FIG. 6, the % Singulation, % Population, % Skips, and % Multiples were evaluated on a treatment combination of Poncho/VOTiVO and graphite treatment as compared to a treatment combination of Poncho/VOTiVO and fluency powder (oxidized polyethylene wax) at 0.56 oz/cwt seed, 0.75 oz/cwt seed, 1.5 oz/cwt seed, and 3 oz/cwt seed. As set forth in FIG. 6, the % Singulation, % Population, % Skips, and % Multiples of seeds coated with powdered oxidized polyethylene wax as a lubricant were in line with those with as compared to graphite.

TABLE 5

| | | Grams | |
|---|---|---|---|
| | | clothianidin in | |
| | Total Grams | total dust per | % decrease |
| | dust per | 100,000 kernels | of clothianidin |
| Treatment & Planter | 100,000 | (HPLC analysis | in dust versus |
| Lubricant | kernels | of filters) | Graphite |
| Poncho/VOTiVO | 0.21 | 0.04 | −68% |
| (no lubricant) | | | |
| Poncho/VOTiVO with | 0.92 | 0.12 | Control |
| Graphite at 0.56 oz/ | | | |
| cwt seed | | | |
| Poncho/VOTiVO with | 0.20 | 0.03 | −79% |
| Fluency Powder at | | | |
| 0.56 oz/cwt seed | | | |
| Poncho/VOTiVO with | 0.10 | 0.02 | −84% |
| Fluency Powder at | | | |
| 0.75 oz/cwt seed | | | |
| Poncho/VOTiVO with | 0.17 | 0.02 | −85% |
| Fluency Powder at | | | |
| 1.5 oz/cwt seed | | | |
| Poncho/VOTiVO with | 0.41 | 0.02 | −81% |
| Fluency Powder at | | | |
| 3 oz/cwt seed | | | |

In Table 6, the total grams of dust per 100,000 kernels and grams of clothianidin in total dust per 100,000 kernels for seeds treated with Poncho/VOTiVO and fluency powder (polyethylene wax) as a planter lubricant were evaluated. As set forth in Table 6, a treatment combination of Poncho/VOTiVO and graphite treatment was compared to a treatment combination of Poncho/VOTiVO and fluency powder (oxidized polyethylene wax) at 0.56 oz/cwt seed, 0.75 oz/cwt seed, 1.5 oz/cwt seed, and 3 oz/cwt seed. The dust and clothianidin exposure were measured with a Case IH Vacuum Meter. The data in Table 6 represents an average of two seed sources.

In an aspect, a repelling, controlling, or directing compound or composition described herein is added to a planter lubricant, for example, in the methods and compositions described in Tables 5 and 6. Such a composition has the ability to reduce dust emission while repelling, controlling, or directing insects.

TABLE 6

| | | Grams | |
|---|---|---|---|
| | | clothianidin in | |
| | Total Grams | total dust per | % decrease |
| | dust per | 100,000 kernels | of clothianidin |
| Treatment & Planter | 100,000 | (HPLC analysis | in dust versus |
| Lubricant | kernels | of filters) | Graphite |
| Poncho/VOTiVO | 2.08 | 0.22 | −21% |
| (no lubricant) | | | |
| Poncho/VOTiVO with | 3.80 | 0.27 | Control |
| Graphite at 0.56 oz/ | | | |
| cwt seed | | | |
| Poncho/VOTiVO with | 1.86 | 0.16 | −41% |
| Fluency Powder at | | | |
| 0.56 oz/cwt seed | | | |
| Poncho/VOTiVO with | 1.73 | 0.14 | −48% |
| Fluency Powder at | | | |
| 0.75 oz/cwt seed | | | |
| Poncho/VOTiVO with | 1.97 | 0.13 | −53% |
| Fluency Powder at | | | |
| 1.5 oz/cwt seed | | | |
| Poncho/VOTiVO with | 3.64 | 0.14 | −51% |
| Fluency Powder at | | | |
| 3 oz/cwt seed | | | |

### Example 4

Example 4 sets forth the Poncho 1250+VOTiVO Corn dust levels with polyethylene wax as a planter lubricant.

In Table 7, the total grams of dust per 100,000 kernels and grams of clothianidin in total dust per 100,000 kernels for seeds treated with Poncho 1250+VOTiVO and fluency powder (polyethylene wax) as a planter lubricant were evaluated. As set forth in Table 3, a treatment combination of Poncho 1250+VOTiVO and graphite treatment was compared to a treatment combination of Poncho 1250+VOTiVO and fluency powder (oxidized polyethylene wax) at 0.56 oz/cwt seed, 0.75 oz/cwt seed, 1.5 oz/cwt seed, and 3 oz/cwt seed. The dust and clothianidin exposure were measured with a Heubach Dustmeter. The data in Table 7 represents an average of two seed sources.

In FIG. 8, the % Singulation, % Population, % Skips, and % Multiples were evaluated on a treatment combination of Poncho 1250+VOTiVO and graphite treatment as compared to a treatment combination of Poncho 1250+VOTiVO and fluency powder (oxidized polyethylene wax) at 0.56 oz/cwt seed, 0.75 oz/cwt seed, 1.5 oz/cwt seed, and 3 oz/cwt seed. As set forth in FIG. 8, the % Singulation, % Population, % Skips, and % Multiples of seeds coated with powdered oxidized polyethylene wax as a lubricant were in line with those with as compared to graphite.

In an aspect, a repelling, controlling, or directing compound or composition described herein is added to a planter lubricant, for example, in the methods and compositions described in Tables 7 and 8. Such a composition has the ability to reduce dust emission while repelling, controlling, or directing insects.

TABLE 7

| | | Grams | |
|---|---|---|---|
| | | clothianidin in | |
| | Total Grams | total dust per | % decrease |
| | dust per | 100,000 kernels | of clothianidin |
| Treatment & Planter | 100,000 | (HPLC analysis | in dust versus |
| Lubricant | kernels | of filters) | Graphite |
| Poncho 1250 + | 0.18 | 0.03 | −69% |
| VOTiVO (no | | | |
| lubricant) | | | |
| Poncho 1250 + | 0.63 | 0.09 | Control |
| VOTiVO with | | | |
| Graphite at 0.56 oz/ | | | |
| cwt seed | | | |
| Poncho 1250 + | 0.06 | 0.01 | −89% |
| VOTiVO with Fluency | | | |
| Powder at 0.56 oz/ | | | |
| cwt seed | | | |
| Poncho 1250 + | 0.17 | 0.01 | −91% |
| VOTiVO with Fluency | | | |
| Powder at 0.75 oz/ | | | |
| cwt seed | | | |
| Poncho 1250 + | 0.10 | 0.01 | −88% |
| VOTiVO with Fluency | | | |
| Powder at 1.5 oz/ | | | |
| cwt seed | | | |
| Poncho 1250 + | 0.09 | 0.01 | −86% |
| VOTiVO with Fluency | | | |
| Powder at 3 oz/ | | | |
| cwt seed | | | |

In Table 8, the total grams of dust per 100,000 kernels and grams of clothianidin in total dust per 100,000 kernels for seeds treated with Poncho 1250+VOTiVO and fluency powder (polyethylene wax) as a planter lubricant were evaluated. As set forth in Table 8, a treatment combination of Poncho 1250+VOTiVO and graphite treatment was compared to a treatment combination of Poncho 1250+VOTiVO and fluency powder (oxidized polyethylene wax) at 0.56 oz/cwt seed, 0.75 oz/cwt seed, 1.5 oz/cwt seed, and 3 oz/cwt seed. The dust and clothianidin exposure were measured with a Case IH Vacuum Meter. The data in Table 8 represents an average of two seed sources.

TABLE 8

| | | Grams | |
|---|---|---|---|
| | | clothianidin in | |
| | Total Grams | total dust per | % decrease |
| | dust per | 100,000 kernels | of clothianidin |
| Treatment & Planter | 100,000 | (HPLC analysis | in dust versus |
| Lubricant | kernels | of filters) | Graphite |
| Poncho 1250 + | 1.83 | 0.31 | −1% |
| VOTiVO (no | | | |
| lubricant) | | | |
| Poncho 1250 + | 3.08 | 0.31 | Control |
| VOTiVO with | | | |
| Graphite at 0.56 oz/ | | | |
| cwt seed | | | |
| Poncho 1250 + | 1.02 | 0.14 | −55% |
| VOTiVO with Fluency | | | |
| Powder at 0.56 oz/ | | | |
| cwt seed | | | |
| Poncho 1250 + | 1.09 | 0.14 | −55% |
| VOTiVO with Fluency | | | |
| Powder at 0.75 oz/ | | | |
| cwt seed | | | |
| Poncho 1250 + | 1.22 | 0.12 | −63% |
| VOTiVO with Fluency | | | |
| Powder at 1.5 oz/ | | | |
| cwt seed | | | |
| Poncho 1250 + | 2.19 | 0.13 | −57% |
| VOTiVO with Fluency | | | |
| Powder at 3 oz/ | | | |
| cwt seed | | | |

### Example 5

Example 5 sets forth the feeding station arrangement for the honeybee repulsion experiments described herein.

FIG. 5 describes the feeding station arrangement (A and B) for the honeybee repulsion experiments described herein. As set forth in FIG. 10, panel (A) sets forth the bee cage positions on the left portion of panel (A) with the randomized feeding station positions on the right portion of panel (A). Panel (B) sets forth an alignment of the randomized feeding station positions with a distance of two meters between feeding stations. A total of eight feeding stations were evaluated at a ten meter distance in front of the respective bee hives. The feeding stations were placed two meters apart from one another.

Honeybees were trained to deep feeders (eight positions), each containing a 50% sucrose solution for one day. After the honeybees were trained to each feeder, the 50% sucrose feeder at randomized positions 1-8 was replaced with a shallow feeder containing a combination of repelling compounds and a 50% sucrose solution according to Table 9. In accordance with FIGS. 5 and 6, 2% by weight of Camphor oil (T4), Ajowan oil (T5), Camphor powder (T6), Rosemary oil (T7), and 2-Decanone (T8) in combination with a 50% sucrose treatment were added to feeders on day two. Honeybees in randomized position 8 (2-Decanone) exhibited repellency at 24 hours.

### Example 6

Example 6 describes the effectiveness of various active agents in repelling honeybees.

Table 9 describes active agents evaluated for bee repulsion and their randomized feeding station positions. As described in Table 4, T1 (control), T2 (control), T3 (control), T4 (Camphor oil), T5 (Ajowan oil), T6 (Camphor powder), T7 (Rosemary oil), and T8 (2-Decanone).

TABLE 9

| | | Randomized |
|---|---|---|
| | | position |
| Number | | (feeding station |
| Code | Treatment | number) |
| 1 | C (untreated 50% sucrose) | 6 |
| 2 | C (untreated 50% sucrose) | 7 |
| 3 | C (untreated 50% sucrose) | 1 |
| 4 | Camphor oil 2.18 g/100.4 g with 50% sucrose | 4 |
| 5 | Ajowan oil 3.25 g/101.1 g with 50% sucrose | 2 |
| 6 | Camphor powder diluted to 100 fluid g with | 5 |
| | 50% sucrose | |
| 7 | Rosemary oil 2.09 g/114 g 1 g with 50% | 3 |
| | sucrose | |
| 8 | 2-Decanone 8.6 g/111.83 g 1 g with 50% | 8 |
| | sucrose | |

FIG. 5 evaluates the number of bees visiting a respective feed station over a time interval. FIG. 6 sets forth the mean number of honeybees visiting feeding station over a period of four hours. 2-decanone was highly repellent for the full 4 hour assessment period and was still repellent after 24 hours. Rosemary oil exhibited initial repellency, but this repellency was not fully maintained for the full 4 hour assessment period

### Example 7

Example 7 sets forth the stability of Poncho with an insect repellent, Eugenol.

Table 10 describes a stability test with a combination of Eugenol and Poncho evaluated at room temperature, 40° C., and 54° C. at zero time, 3 days, and 7 days as confirmed by high performance liquid chromatography (HPLC). As described in Table 5, the content of clothianidin, which is the active agent in Poncho, exhibited chemical stability when combined with an insect and bee repellent Eugenol for up to 54° C. for seven days.

TABLE 10
Clothianidin content

| | zero | after | after |
|---|---|---|---|
| | time | 3 days | 7 days |
| Room Temperature | | | |
| Poncho 600 only | 46.30% | 43.88% | 45.19% |
| Poncho 600 + Eugenol at .0053 | 46.25% | 44.48% | 46.02% |
| mg/ml | | | |
| Poncho 600 + Eugenol at .0372 | 43.36% | 35.90% | 41.72% |
| mg/ml | | | |
| 40° C. | | | |
| Poncho 600 only | 46.30% | 44.60% | 44.93% |
| Poncho 600 + Eugenol at .0065 | 46.25% | 44.10% | 44.48% |
| mg/ml | | | |
| Poncho 600 + Eugenol at .0086 | 43.36% | 40.01% | 40.23% |
| mg/ml | | | |
| 54° C. | | | |
| Poncho 600 only | 46.30% | 45.16% | 45.19% |
| Poncho 600 + Eugenol at .0029 | 46.25% | 43.80% | 43.41% |
| mg/ml | | | |
| Poncho 600 + Eugenol at .0203 | 43.36% | 42.53% | 40.65% |
| mg/ml | | | |

### Example 8

Example 8 sets forth the stability of Poncho with an insect repellent, α-terpineol.

Table 11 describes a stability test with a combination of α-terpineol and Poncho 600 evaluated at room temperature, 40° C., and 54° C. at zero time, 2 days, and 8 days as confirmed by HPLC. As described in Table 6, the content of clothianidin, which is the active agent in Poncho, exhibited chemical stability when combined with an insect and bee repellent alphα-terpineol for up to 54° C. for eight days.

TABLE 11
Clothianidin content

| | zero | after | after |
|---|---|---|---|
| | time | 2 days | 8 days |
| Room Temperature | | | |
| Poncho 600 only | 45.31% | 46.51% | 55.33% |
| Poncho 600 + α-terpineol at .4173 | 45.45% | 44.62% | 53.62% |
| mg/ml | | | |
| Poncho 600 + α-terpineol at .3600 | 45.29% | 45.32% | 45.07% |
| mg/ml | | | |
| 40° C. | | | |
| Poncho 600 + α-terpineol at .3659 | 45.45% | 44.97% | 45.27% |
| mg/ml | | | |
| Poncho 600 + α-terpineol at ..3981 | 45.29% | 44.83% | 45.37% |
| mg/ml | | | |
| 54° C. | | | |
| Poncho 600 + α-terpineol at .4004 | 45.45% | 46.65% | 48.18% |
| mg/ml | | | |
| Poncho 600 + α-terpineol at .3276 | 45.29% | 46.81% | 50.65% |
| mg/ml | | | |

### Example 9

Example 9 sets forth the stability of Gaucho with an insect repellent, α-terpineol.

Table 12 describes a stability test with a combination of α-terpineol and Gaucho evaluated at room temperature, 40° C., and 54° C. at zero time, 2 days, and 8 days as confirmed by high performance liquid chromatography (HPLC). As described in Table 12, the content of imidacloprid, which is the active agent in Gaucho, exhibited chemical stability when combined with an insect and bee repellent α-terpineol for up to 54° C. for eight days.

TABLE 12
Imidacloprid content

| | zero | after | after |
|---|---|---|---|
| | time | 2 days | 8 days |
| Room Temperature | | | |
| Gaucho 600 only | 47.43% | 47.96% | 51.21% |
| Gaucho 600 + α-terpineol at .3745 | 48.59% | 47.72% | 48.21% |
| mg/ml | | | |
| Gaucho 600 + α-terpineol at .4594 | 48.19% | 48.85% | 47.89% |
| mg/ml | | | |
| 40° C. | | | |
| Gaucho 600 + α-terpineol at .4140 | 48.59% | 47.66% | 48.61% |
| mg/ml | | | |
| Gaucho 600 + α-terpineol at .5787 | 48.19% | 48.98% | 49.32% |
| mg/ml | | | |
| 54° C. | | | |
| Gaucho 600 + α-terpineol at .4154 | 48.59% | 48.82% | 50.51% |
| mg/ml | | | |
| Gaucho 600 + α-terpineol at .4392 | 48.19% | 49.32% | 53.16% |
| mg/ml | | | |

1. A method of reducing seed dust and repelling, controlling, or directing an insect comprising treating a seed with:
(a) one or more organic lubricant compositions; and
(b) at least one insect repelling, controlling, and/or directing compound or composition.

2. The method of claim 1, wherein said seed has been treated with a treating agent selected from the group consisting of an insecticidal, pesticidal, fungicidal, and herbicidal treating agent.

3. The method of claim 2, wherein said treating agent is selected from the group consisting of acetamiprid, clothianidin, dinotefuran, imidacloprid, nitenpyram, thiacloprid, thiamethoxam, and abamectin.

4. The method of claim 1, wherein said seed is selected from the group consisting of corn seed, cotton seed, rice seed, sorghum seed, oat seed, rye seed, barley seed, soybean seed, vegetable seed, wheat seed, sugarbeat seed, sunflower seed, lettuce seed, and spinach seed.

5. The method of claim 1, wherein said one or more organic lubricant compositions comprises a wax composition.

6. The method of claim 5, wherein said wax is selected from the group consisting of polyethylene wax, carnuba wax, paraffin wax, polypropylene wax, oxidized polyethylene wax, montan wax, microcrystalline wax, Fischer-Tropsch wax, amide wax, ethylene-acrylic-acid wax, polyolefin wax, ethylene bis stearamide wax, bees wax, lanolin wax, and vegetable wax.

7. The method of claim 6, wherein said wax is selected from the group consisting of polyethylene wax, carnuba wax, paraffin wax, polypropylene wax, and oxidized polyethylene wax.

8. The method of claim 7, wherein said wax is oxidized polyethylene wax.

9. The method of claim 1, wherein said insect is a pollinating insect and optionally a bee.

10. The method of claim 1 comprising reducing dust emission of a planted seed.

11. The method of claim 10, wherein said planted seed is planted with a mechanical planter.

12. The method of claim 11, wherein the dust is released from a mechanical seed planter.

13. The method of claim 1, wherein said one or more organic lubricant compositions is applied to a seed at about 0.5-4.0 oz/cwt.

14. The method of claim 13, wherein said one or more organic lubricant compositions is applied to a seed at about 1.0-3.0 oz/cwt.

15. The method of claim 10, wherein said dust emission is reduced relative to a seed coating comprising talc or graphite.

16. The method of claim 1, wherein said at least one insect repelling, controlling, and/or directing compound or is selected from at least one compound of Formula (I)-(IX) [chemical structure]
in which,
R₁ and R₂ are independently selected from methyl, ethyl, propyl, isopropyl, cyclopropyl, butyl, iso-butyl, tert-butyl, pentyl, hexyl, heptyl, octyl, nonyl, decyl, undecyl and substituted or non substituted C₂-C₁₄-alkyl, substituted or non substituted C₂-C₁₄ alkenyl, a substituted or non substituted C₂-C₁₄-alkynyl, alkyl substituted with halogen, F, Cl, Br, I, oxygen, hydroxyl, alkoxy, cyano, aryloxy, C═C, C≡C; nitrogen, NH2, alkyl amino, dialkyl amine trialkylamino; SH, alkylthio or where R¹ and R² are linked together to form a substituted or unsubstituted (CH₂)₃, (CH₂)₄, (CH₂)₅, (CH₂)₆, (CH₂)₇, (CH₂)₈, (CH₂)₉, (CH₂)₁₀, (CH₂)₁₁, (CH₂)₁₂, (CH₂)₁₃ ring structure; and
R₃ and R₄ are individually selected from H, alkyl, methyl, ethyl, propyl, or butyl;

17. The method according to claim 16, wherein R₁ is methyl or ethyl and R₂ is selected from the group consisting of methyl, ethyl, propyl, isopropyl, cyclopropyl, butyl, iso-butyl, tert-butyl, pentyl, hexyl, heptyl, octyl, nonyl, decyl, undecyl and substituted or non substituted C₂-C₁₄-alkyl, substituted or non substituted C₂-C₁₄ alkenyl, a substituted or non substituted C₂-C₁₄-alkynyl.

18. The method according to claim 1, wherein said at least one insect repelling, controlling, and/or directing compound comprises a C₇-C₁₅ ketone.

19. The method according to claim 18, wherein said C₇-C₁₅ ketone is selected from the group consisting of 3-heptanone, 4-heptanone, cycloheptanone, 2-octanone, 3-octanone, cyclooctanone, 2-nonanone, cyclononanone, 2-decanone, 3-decanone, 4-decanone, 5-decanone, 2-undecanone, 2-dodecanone, 2-trideconone, 2-tetradecanone, 2-pentadecanone, 2-hexadecanone, 2-heptadecanone, cyclodeconone, and sulfur analogs of 2-decanone.

20. The method according to claim 16, wherein said at least one compound of Formula (I)-(IX) repels at least 90% of the insects for at least 24 hours.

21. The method according to claim 1, wherein said method further comprises at least one compound selected from the group consisting of camphor, camphor oil, camphor powder, tea tree oil, pine oil, rosemary powder, and rosemary oil.

22. The method according to claim 18, wherein said C₇-C₁₅ ketone compound repels a larger percentage of honeybees than an equal percent weight of a compound selected from the group consisting of camphor oil, ajowan oil, camphor powder, and rosemary oil.

23. A seed comprising
(a) one or more insecticidal, pesticidal, fungicidal, or herbicidal treating agents; and
(b) one or more organic lubricant compositions; and
(c) at least one insect repelling, controlling, and/or directing compounds or compositions.

24. The seed of claim 23, wherein said one or more insecticidal, pesticidal, fungicidal, or herbicidal treating agents is selected from the group consisting of acetamiprid, clothianidin, dinotefuran, imidacloprid, nitenpyram, thiacloprid, thiamethoxam, and abamectin.

25. The seed of claim 23, wherein said seed is selected from the group consisting of corn seed, cotton seed, rice seed, sorghum seed, oat seed, rye seed, barley seed, soybean seed, vegetable seed, wheat seed, sugarbeat seed, sunflower seed, lettuce seed, and spinach seed.

26. The seed of claim 23, wherein said one or more organic lubricant compositions comprises a wax composition.

27. The seed of claim 26, wherein said wax is selected from the group consisting of polyethylene wax, carnuba wax, paraffin wax, polypropylene wax, oxidized polyethylene wax, powdered oxidized polyethylene wax, montan wax, microcrystalline wax, Fischer-Tropsch wax, amide wax, ethylene-acrylic-acid wax, polyolefin wax, ethylene bis stearamide wax, bees wax, lanolin wax, and vegetable wax.

28. The seed of claim 26, wherein said wax is selected from the group consisting of polyethylene wax, carnuba wax, paraffin wax, polypropylene wax, oxidized polyethylene wax, and powdered oxidized polyethylene wax.

29. The seed of claim 23, wherein said at least one insect repelling, controlling, and/or directing compound is selected from at least one compound of Formula (I)-(IX) [chemical structure]
in which,
R₁ and R₂ are independently selected from methyl, ethyl, propyl, isopropyl, cyclopropyl, butyl, iso-butyl, tert-butyl, pentyl, hexyl, heptyl, octyl, nonyl, decyl, undecyl and substituted or non substituted C₂-C₁₄-alkyl, substituted or non substituted C₂-C₁₄ alkenyl, a substituted or non substituted C₂-C₁₄-alkynyl, alkyl substituted with halogen, F, Cl, Br, I, oxygen, hydroxyl, alkoxy, cyano, aryloxy, C═C, C≡C; nitrogen, NH2, alkyl amino, dialkyl amine trialkylamino; SH, alkylthio or where R¹ and R² are linked together to form a substituted or unsubstituted (CH₂)₃, (CH₂)₄, (CH₂)₅, (CH₂)₆, (CH₂)₇, (CH₂)₈, (CH₂)₉, (CH₂)₁₀, (CH₂)₁₁, (CH₂)₁₂, (CH₂)₁₃ ring structure; and
R₃ and R₄ are individually selected from H, alkyl, methyl, ethyl, propyl, or butyl;

30. The seed according to claim 29, wherein R₁ is methyl or ethyl and R₂ is selected from the group consisting of methyl, ethyl, propyl, isopropyl, cyclopropyl, butyl, iso-butyl, tert-butyl, pentyl, hexyl, heptyl, octyl, nonyl, decyl, undecyl and substituted or non substituted C₂-C₁₄-alkyl, substituted or non substituted C₂-C₁₄ alkenyl, a substituted or non substituted C₂-C₁₄-alkynyl.

31. The seed according to claim 23, wherein said at least one insect repelling, controlling, and/or directing compound comprises a C₇-C₁₅ ketone.

32. The seed according to claim 31, wherein said C₇-C₁₅ ketone is selected from the group consisting of 3-heptanone, 4-heptanone, cycloheptanone, 2-octanone, 3-octanone, cyclooctanone, 2-nonanone, cyclononanone, 2-decanone, 3-decanone, 4-decanone, 5-decanone, 2-undecanone, 2-dodecanone, 2-trideconone, 2-tetradecanone, 2-pentadecanone, 2-hexadecanone, 2-heptadecanone, cyclodeconone, and sulfur analogs of 2-decanone.

33. The seed according to claim 29, wherein said at least one compound of Formula (I)-(IX) repels at least 90% of the insects for at least 24 hours.

34. The seed according to claim 23, wherein said seed further comprises at least one compound selected from the group consisting of camphor, camphor oil, camphor powder, tea tree oil, pine oil, rosemary powder, and rosemary oil.

35. A planter or hopper comprising
(a) one or more organic lubricant compositions; and
(b) at least one insect repelling, controlling, and/or directing compound or composition.

36. The planter or hopper of claim 35, comprising
(c) one or more insecticidal, pesticidal, fungicidal, or herbicidal treating agents.

37. The planter or hopper of claim 36, wherein said one or more insecticidal, pesticidal, fungicidal, or herbicidal treating agents is selected from the group consisting of acetamiprid, clothianidin, dinotefuran, imidacloprid, nitenpyram, thiacloprid, thiamethoxam, and abamectin.

38. The planter or hopper of claim 35, wherein said planter or hopper comprise seed.

39. The planter of hopper of claim 38, comprising treated seed optionally where said treated seed is treated with one or more insecticidal, pesticidal, fungicidal, or herbicidal treating agents.

40. The planter or hopper of claim 38, wherein said seed is selected from the group consisting of corn seed, cotton seed, rice seed, sorghum seed, oat seed, rye seed, barley seed, soybean seed, vegetable seed, wheat seed, sugarbeat seed, sunflower seed, lettuce seed, and spinach seed.

41. The planter or hopper of claim 35, wherein said one or more organic lubricant compositions comprises a wax composition.

42. The planter or hopper of claim 41, wherein said wax is selected from the group consisting of polyethylene wax, carnuba wax, paraffin wax, polypropylene wax, oxidized polyethylene wax, powdered oxidized polyethylene wax, montan wax, microcrystalline wax, Fischer-Tropsch wax, amide wax, ethylene-acrylic-acid wax, polyolefin wax, ethylene bis stearamide wax, bees wax, lanolin wax, and vegetable wax.

43. The planter or hopper of claim 35, wherein said at least one insect repelling, controlling, and/or directing compound is selected from at least one compound of Formula (I)-(IX) [chemical structure]
in which,
R₁ and R₂ are independently selected from methyl, ethyl, propyl, isopropyl, cyclopropyl, butyl, iso-butyl, tert-butyl, pentyl, hexyl, heptyl, octyl, nonyl, decyl, undecyl and substituted or non substituted C₂-C₁₄-alkyl, substituted or non substituted C₂-C₁₄ alkenyl, a substituted or non substituted C₂-C₁₄-alkynyl, alkyl substituted with halogen, F, Cl, Br, I, oxygen, hydroxyl, alkoxy, cyano, aryloxy, C═C, C≡C; nitrogen, NH2, alkyl amino, dialkyl amine trialkylamino; SH, alkylthio or where R¹ and R² are linked together to form a substituted or unsubstituted (CH₂)₃, (CH₂)₄, (CH₂)₅, (CH₂)₆, (CH₂)₇, (CH₂)₈, (CH₂)₉, (CH₂)₁₀, (CH₂)₁₁, (CH₂)₁₂, (CH₂)₁₃ ring structure; and
R₃ and R₄ are individually selected from H, alkyl, methyl, ethyl, propyl, or butyl;

44. The planter or hopper of claim 43, wherein R₁ is methyl or ethyl and R₂ is selected from the group consisting of methyl, ethyl, propyl, isopropyl, cyclopropyl, butyl, iso-butyl, tert-butyl, pentyl, hexyl, heptyl, octyl, nonyl, decyl, undecyl and substituted or non substituted C₂-C₁₄-alkyl, substituted or non substituted C₂-C₁₄ alkenyl, a substituted or non substituted C₂-C₁₄-alkynyl.

45. The planter or hopper of claim 35, wherein said at least one insect repelling, controlling, and/or directing compound comprises a C₇-C₁₅ ketone.

46. The planter or hopper of claim 45, wherein said C₇-C₁₅ ketone is selected from the group consisting of 3-heptanone, 4-heptanone, cycloheptanone, 2-octanone, 3-octanone, cyclooctanone, 2-nonanone, cyclononanone, 2-decanone, 3-decanone, 4-decanone, 5-decanone, 2-undecanone, 2-dodecanone, 2-trideconone, 2-tetradecanone, 2-pentadecanone, 2-hexadecanone, 2-heptadecanone, cyclodeconone, and sulfur analogs of 2-decanone.

47. The planter or hopper of claim 35, wherein said planter or hopper further comprises at least one compound selected from the group consisting of camphor, camphor oil, camphor powder, tea tree oil, pine oil, rosemary powder, and rosemary oil.

48. The method of claim 1, wherein said at least one insect repelling, controlling, and/or directing compound comprises 2-decanone.

49. The seed of claim 23, wherein said at least one insect repelling, controlling, and/or directing compound comprises 2-decanone.

50. The planter or hopper of claim 35, wherein said at least one insect repelling, controlling, and/or directing compound comprises 2-decanone.
